(19) United States
(12) Patent Application Publication
(10) Pub. No.: US 2016/0145011 A1
(43) Pub. Date: May 26, 2016

(54) Container Lid Construction and Associated Methods

(71) Applicant: Pavel SAVEL, Wheaton, IL (US)

(72) Inventor: Pavel SAVEL, Wheaton, IL (US)

(21) Appl. No.: 14/900,148

(22) PCT Filed: Jul. 2, 2014
(86) PCT No.: PCT/US2014/045325

§ 371 Date: Dec. 19, 2015

Related U.S. Application Data
(60) Provisional application No. 61/900,148, filed on Nov. 5, 2013.

(51) Int. Cl. B65D 47/04; B65B 35/50; B65G 57/16; B65B 63/02

(52) U.S. Cl. CPC B65D 47/043; B65B 63/02; B65B 35/50; B65G 57/165; B65D 2543/00046

(57) ABSTRACT

A resilient lid insert or membrane construction is outfitted upon a lidded beverage container for enabling the user to transfer heat from a relatively hot assembly-contained beverage prior to consumption. The insert or membrane construction may include a resilient material and may optionally provide a beverage-damming structure. The membrane construction defines beverage-containing and beverage-cooling compartments. The membrane construction may include at least one aperture for letting matter intermediate the beverage-containing and beverage-cooling compartments. The beverage-cooling compartment receives heat from the beverage received therein and thereby enables the beverage to cool before being outlet via a primary outlet. The resilient membrane construction may be biasable intermediate a relaxed and an actuated configuration. The actuated configuration of the lid construction enables a relatively more compact lid construction stacking arrangement, which stacking arrangement may spring into a decompressed state when released therefrom.

### PRIOR HISTORY

This patent application is a U.S. national stage entry application based on International Patent Application No. PCT/US2014/045325 filed in the United States Patent and Trademark Office (USPTO) as International Receiving Office (RO) on 2 Jul. 2014, which International Patent Application claimed the benefit of U.S. Provisional Patent Application No. 61/842,214 filed in the USPTO on 2 Jul. 2013.

### BACKGROUND OF THE INVENTION

1. Field of the Invention

The present invention relates generally to a lid construction or assembly for outfitting a hot beverage container. More particularly, the present invention relates to a lid construction for outfitting a lidded, hot beverage container for enabling the drinker to control and/or slow the flow rate of hot beverage from the container so as to prevent spillage and transfer heat from the hot beverage prior to consumption. Certain lid construction methodologies, including lid packaging methodology, in view of the lid construction according to the present invention are further supported by the following specifications.

2. Brief Description of the Prior Art

The broad field of lids for hot beverage containers and hot beverage container assemblies inclusive of lids is exceedingly well-developed. The art relating to means for cooling hot beverages prior to consumption is a bit more limited, as is the art related to lid packaging methods. Some of the more pertinent prior relating to hot beverage container lid developments and lid packaging methods are believed to be briefly described hereinafter.

U.S. Pat. No. 3,701,456 ('456 patent), issued to Alroy, for example, discloses Stackable Members. The '456 patent describes articles of deformable material formed with wall-based means for permitting a number of articles nested one within the other to be compressed into a smaller volume when force is applied thereto and which also cause the articles to move apart when the force is removed. In a preferred embodiment of the invention, deformable members of two different shapes are used. One member includes a flat wall which is connected by what is effectively a hinge to a wall of the article. When force is applied to the flat wall of the member, it assumes a somewhat domed shape.

The other member includes a domed wall also connected by a hinge to the article wall. When force is applied to this second member, the domed wall assumes a flatter shape. The articles are stacked within each other so that a deformable member with a flat wall is in vertical alignment with a deformable member with a domed wall. When force is applied to the two articles, they move closer together, as both types of members change their shape in the manner previously described, to decrease the space between the adjacent walls of the articles having the deformable members thereon to increase the stacking density.

U.S. Pat. No. 5,873,493 ('493 patent), issued to Robinson, discloses an Integrally Molded Measurer Dispenser. The '493 patent describes a closure providing a side wall having first and second distal ends, an inner surface and an outer perimeter. A cone-shaped divider projects inwardly and upwardly from a lower perimeter of the side wall and includes a drain-back orifice therethrough. The cone-shaped divider further includes an apex having an opening therethrough. The closure further provides a lid pivotally attached at an outer diameter thereof to the outer perimeter of the side wall first distal end by an integral hinge. The lid includes a shaped substantially conforming to the side wall perimeter.

U.S. Pat. No. 6,176,390 ('390 patent), issued to Kemp, discloses a Container Lid with Cooling Reservoir. The '390 patent describes a container lid with a cooling reservoir for releasably covering a disposable cup containing a hot beverage. The cooling reservoir includes a side wall with a small opening to allow a small volume of the hot beverage to pass into the cooling reservoir in which the beverage sufficiently cools down to enable the consumer to sip the beverage.

U.S. Pat. No. 6,305,571 ('571 patent), issued to Chu, discloses a Lid Device with Splashless Baffle. The '571 patent describes a splashless lid device for dispensing fluid contained in a drinking container, wherein the container includes a lip portion which defines an opening into the container. A mounting portion is configured to sealingly engage the lip portion of the container and to be removable. A top cover is coupled to the mounting portion and extends substantially laterally across the container opening when the mounting portion is sealingly engaged with the container lip.

The top cover includes a top wall and a bottom wall cooperating to define an interior cavity. The top wall has a drinking port in flow communication with the interior cavity. The bottom wall defines a baffle opening which extends into the interior cavity and is adapted to reduce splashing of fluid through the opening fluid dispensed from the container must pass through the baffle opening and into the interior cavity before passing through the drinking port.

U.S. Pat. No. 7,448,510 ('510 patent), issued to Pavlopoulos, discloses a Cup Assembly having a Cooling Compartment. The '510 patent describes a cup assembly comprising a cup and a lid to define therebetween a first passage and a second passage to allow a liquid cooling compartment between the lid and the cup to be filled with liquid contained in the cup when the first passage is clear and the second passage is blocked and the liquid in the liquid cooling compartment is able to flow out of an outlet in communication with the liquid cooling compartment when the second passage is clear and the first passage is blocked.

U.S. Pat. No. 8,267,275 ('275 patent), issued to Peitersen, discloses a Beverage container top having a reservoir for liquid cooling. The '275 patent describes a beverage cooling container top apparatus including a bottom reservoir wall portion which includes a cooling reservoir fill channel. A top reservoir wall portion includes a cooling reservoir access channel; the top reservoir wall provides a closed top; and a side wall portion extends between the bottom reservoir wall portion and the top reservoir wall portion.

A container-reception portion is connected to the side wall portion. The bottom reservoir wall portion, the top reservoir wall portion, and the side wall portion define a cooling reservoir. Preferably, cooling fins are located on the top reservoir wall portion. A main reservoir access channel can be provided to bypass the cooling reservoir when the contents of the beverage cup are no longer hot. The apparatus of the invention holds and cools a portion of the hot contents of a beverage cup to prevent a user from a very unpleasant burning of the lips and tongue from the hot beverage in the beverage cup.

U.S. Pat. No. 8,459,491 ('491 patent), issued to Savenok, discloses a Hot Beverage Container Assembly and Insert. The '491 patent describes an insert assembly outfittable upon a lidded beverage container for enabling the user to transfer heat from a relatively hot assembly-contained beverage so as to prevent scalding prior to consumption. The insert assembly comprises a damming structure and a rim-engaging structure. The damming structure is formed from a semi-rigid material and is sized and shaped for receipt within the upper rim perimeter of a container structure.

The rim-engaging structure is formed from a flexible material and extends outwardly from the beverage-damming structure. The rim-engaging structure is received intermediate the upper container rim and a lid for defining beverage-containing and beverage-cooling compartments. The insert structure comprises first and second apertures for outletting beverage and inletting air intermediate the beverage-containing and beverage-cooling compartments. The beverage-cooling compartment receives heat from the beverage received therewithin and thereby enables the beverage to cool before being outlet via a primary outlet of a lid.

United States Patent Application Publication No. 2005/0167294, authored by Swayne, describes a Cover and Media Disk Display Apparatus for a Container or Lid Assembly with a top portion that defines a container opening area including a bottom lid member sized to fit over the top portion of the container. The bottom lid member includes an extension portion configured to mechanically engage the bottom lid member with the top portion of the container and to provide a peripheral structure with a peripheral structure area larger than the container opening area. The lid assembly also includes a top lid member configured to mechanically engage with the bottom lid member such that a premium storage space is provided therebetween.

United States Patent Application Publication No. 2007/0062943, authored by Bosworth, Sr., describes a container lid for a cup-type beverage which includes within the lid a disc-shaped media in which the lid is adapted to be releasably affixed to the beverage container and where the lid is protected from the beverage within the container and wherein the disc may be removed from the lid and utilized for entertainment purposes.

United States Patent Application Publication No. 2010/0264150, authored by Leon et al., describes a disposable beverage cup comprising a ledge between the cup's rim and the grasping portion of the cup that is commonly held in the user's hand. The ledge, which comprises a curb, a horizontal plane, and one or more indentations, acts as a barrier between the user's hand and other objects, preventing a lid that has been press fit onto the cup's rim from being dislodged. In order to remove the lid, the user must insert a finger and/or thumb into the indentation(s) and press upward on the lid. The cup has a contour between the ledge and the grasping portion with ergonomic features to increase the user's comfort in handling the cup.

United States Patent Application Publication No. 2010/0320220, authored by Hussey et al., describes a plastic lid for a drink container such as a coffee cup. The plastic lid is provided with an ancillary access facility in the form of an opening or a part of the lid easily removable to form an opening. The ancillary access facility allows a person to drink from the container without removal of the lid. After the ancillary access facility has been cleaned or decontaminated it is protected by the application of a protective cover.

The protective cover may have a variety of shapes, for example, it may cover the entire lid or it may cover only a selected part of the lid, for example, only the area of the lid involving the ancillary access facility. The protective cover protects the ancillary access facility from the inadvertent transfer of germs to the drinking area by the person dispensing the drinks as they push the lid down with their hands to seal the lid to the container top. The protective covers are arranged to be easily stripped from the lid by the application of mere finger pressure.

United States Patent Application Publication No. 2011/0284564, authored by Hsieh et al. describes disposable cup lid of the present invention includes an engaging portion, a hump portion, a lid surface, and a connection opening. The engaging portion is used for engaging with a cup. At least part of the hump portion is formed annularly inside of the engaging portion. The lid surface is connected to the hump portion. The connection opening is defined on the lid surface, and said connection opening is used to communicate with an interior of the cup. The hump portion is adjacent to the hump portion. A top of the hump portion is higher than the connection opening, and a vertical distance from the top of the hump portion to the connection opening is between 4 to 30 millimeters.

United States Patent Application Publication No. 2012/0125949, authored by Freemen, describes a compartmented lid for conveying at least two liquids simultaneously, the compartmented lid comprising a lid, the lid further comprising a rim, a substantially flat top crowning the rim, the top further comprising an exterior surface, an interior surface, and at least one portal with an aperture; and a compartment comprising an inner wall, the compartment further comprising a basin operably attached to the interior surface of the top of the lid and at least one channel located on the inner wall of the compartment. An opening formed by the channel for dispensing a liquid or other product stored within the confines of the basin is formed when a cover is secured to the upper portion.

United States Patent Application Publication No. 2013/0200088, authored by Muir, describes certain anti-spill disposable and reusable drink-through lids for hot and cold disposable and reusable beverage cups. ‘The present invention is directed to drink-through lids which may be placed over and attached to disposable and reusable beverage cups and which provides a drink-through opening near the perimeter of the lid's top surface for easy drinking. The drink-though lid can accommodate a consumer's lips or a beverage disposable or reusable straw. When used with a straw, the lid and straw combination creates a spill-proof seal.

International Patent Application Publication No. WO 2014066474, authored by Milan, describes a beverage container lid includes an interior cover, an exterior cover, and a hinge connecting the interior cover to the exterior cover. The beverage container is versatile in that it may be adapted for use with a beverage container containing a cold beverage, a hot beverage, or a foamy or creamy beverage. The beverage container lid preferably includes a spout, straw perforations, an elevated portion, a reservoir bottom, a well portion, and a pair of retaining walls preventing direct flow of beverage from a pair of openings in the interior cover to the spout. Methods of use and methods of making the beverage container lid are also described.

From a consideration of the foregoing, it will be noted that the prior art perceives a need for a low cost, disposable hot beverage container assembly lid and/or insert combination (the insert of which combination may be outfitted upon existing lid constructions) so as to enable the user to quickly and easily slow the beverage flow rates for transferring heat from the hot beverage prior to beverage consumption, and which lid and insert combination may be prepackaged in stacked, spring-like columns so that when the user opens the stacked, spring-like column, the lid and insert combinations individually become decompressed and spring into a ready to use configuration. In this last regard, the prior art perceives a need for such a combination hot beverage container lid construction and/or insert assembly combination, and certain packaging methodology supported thereby as summarized in more detail hereinafter.

### SUMMARY OF THE INVENTION

To achieve the aforementioned and other readily apparent objectives, the present invention essentially discloses a hot beverage container lid construction and/or insert assembly for enabling a user/drinker to effectively transfer heat from a relatively hot assembly-contained beverage so as to cool the beverage before it enters the user's/drinker's mouth. The present invention is thus contemplated to provide certain low-cost, disposable means for transferring thermal energy from a relatively hot liquid beverage to relatively cool surroundings so as to prevent scalding before consumption thereof.

When viewed in combination with a hot beverage container assembly, the present invention is believed to comprise a container structure and a lid construction for use in combination with the container structure. The lid construction may preferably comprise an integrally formed or separable resilient insert construction. The insert construction or membrane construction according to the present invention is preferably constructed from a resilient material and thus may have either a relaxed, downwardly-bowed configuration or an actuated, upwardly-bowed configuration. In other words, the actuated, lid-traversing insert or membrane construction is concave relative to the lid bottom or lid mouth or lower lid rim (or concave relative to the lid top), and the relaxed insert construction is convex relative the lower lid rim (or convex relative to the lid top).

The essential container structure is believed to preferably comprise a container bottom, a container wall, and an upper container rim. The upper container rim has a rim perimeter, which rim perimeter preferably extends in a rim plane. The lid structure or construction is believed to preferably comprise a lid top, a lid wall, and a lower lid rim having a container rim-receiving groove. Thus, the lower lid rim receives or is otherwise attachable or cooperable with the upper container rim. The lid top comprises a primary beverage outlet, which primary beverage outlet may be of various sizes and configurations.

Central to the practice of the present invention is the resilient spring-like membrane or insert construction of the lid-insert combination or lid construction. The insert structure or construction preferably comprises a beverage-damming structure or portion and an outer rim-engaging structure or periphery. The insert construction is contemplated to be preferably formed from an elastic or resilient, thermally-insulative, food-grade, and heat-resistant material.

In this last regard, it is contemplated that the material should undergo minimal or minimized structural/dimensional changes when heat is transferred into the material. The insert construction is preferably sized and shaped for receipt within the rim perimeter and, being received, extends in either a concave or convex manner relative to the rim plane. The relaxed configuration is primarily a “for beverage use” configuration and the actuated configuration is primarily a “for packaging use” configuration.

In other words, the present invention provides a hot beverage container insert or membrane construction that is actuable or biasable intermediate two configurations, a first of which configurations is designed for packaging purposes, and a second of which configurations is designed for the basic purposes set forth in issued U.S. Pat. No. 8,459,491 (the '491 patent) issued to the author of these specifications.

The “packaging use” or insert-actuated configuration of the container-lid insert construction involves a configuration that effectively tucks or displaces the body of the insert construction deeper into the lid construction or toward the lid top such that additional or maximized space is created between the concavity of the actuated insert construction and the lower lid rim. By comparison, the space between the convexity of the relaxed insert construction and the lower lid rim is minimized.

The container-lid insert construction is thus preferably formed from a resilient material that is arcuate or bowed upwardly in cross-section toward the lid top when in the actuated or packing use configuration, and when slightly forced or released from its actuated configuration, reverts to its relaxed configuration under the spring-restorative forces inherent to the material toward the relaxed configuration.

The insert construction is thus a “pop-up” type container-lid insert that pops from the actuated state into the relaxed state under one of two basic mechanisms. The first method of popping the insert construction from the actuated configuration to the relaxed configuration is achieved by manually pressing the lid construction from one of a select number of directions. For example, the insert construction may be popped from the actuated state either by pressing against the insert-outfitted lid construction in a radial direction, or by pressing against the insert-outfitted lid construction in an axial direction.

The actions of manually pressing against select portions of the insert-outfitted lid construction may well operate to transfer sufficient force into the actuably biased container-lid insert construction to release the actuated insert construction from its actuated configuration and bring it back to its relaxed configuration under action of the spring-like restorative forces inherent to the material construction thereof. A second method of releasing the insert construction from the actuated configuration to the relaxed configuration is by action of certain packaging methods as is discussed in more detail in the following specifications.

### BRIEF DESCRIPTION OF THE DRAWINGS

Other features of my invention will become more evident from a consideration of the following brief descriptions of patent drawings:

FIG. 1 is a longitudinal cross-sectional depiction of a first alternative lid-insert combination according to the present invention showing the insert construction of the lid-insert combination in a first, actuated or non-relaxed configuration, the insert construction being concave relative to the lid bottom or lid mouth of the lid construction.

FIG. 2 is a longitudinal cross-sectional depiction of the first alternative lid-insert combination according to the present invention showing the insert construction of the lid-insert combination in a second, relaxed configuration, the insert construction being convex relative to the lid bottom or lid mouth of the lid construction.

FIG. 3 is a longitudinal cross-sectional view of a first PRIOR ART lid assembly showing a first lid construction with a PRIOR ART inner beverage-damming insert construction outfitted therewith via a dam-receiving groove formed in the lid wall of the lid construction, the lid insert being planar or parallel relative to the lid bottom or lid mouth of the lid construction.

FIG. 4 is a longitudinal cross-sectional view of a second PRIOR ART lid assembly showing a second lid construction with a PRIOR ART inner beverage-damming insert construction outfitted therewith via a dam-supporting bead or flange formed in the lid wall of the lid construction the lid insert being planar or parallel relative to the lid bottom or lid mouth of the lid construction.

FIG. 5 is a diagrammatic exploded side view depiction showing, from top to bottom, a lid construction, a first alternative resilient insert construction according to the present invention in a relaxed configuration, and a fragmentary container construction (with contained beverage) according to the present invention to show relative positions of the elements before assembly.

FIG. 6 is a diagrammatic exploded side view depiction depicting, from top to bottom, an assembled first alternative lid-insert combination according to the present invention with the resilient insert construction being shown in a relaxed configuration, and a fragmentary container construction (with contained beverage) to show relative positions of the lid-insert combination and container construction before assembly.

FIG. 7 is a diagrammatic exploded side view depiction depicting, from top to bottom, an assembled first alternative lid-insert combination according to the present invention with the resilient insert construction being shown in an actuated configuration, and a fragmentary container construction (with contained beverage) to show relative positions of the lid-insert combination and container construction before assembly.

FIG. 8 is a diagrammatic cross-sectional first sequential side view depiction of the first alternative assembled lid-insert combination and container construction according to the present invention with the resilient insert construction being shown in a relaxed configuration, and a fragmentary container construction with contained beverage to show relative positions of the lid-insert combination and container construction after assembly in an upright position, the contained beverage having a horizontal beverage surface parallel to the a lid top of the lid construction.

FIG. 9 is a diagrammatic cross-sectional second sequential side view depiction of the first alternative assembled lid-insert combination and container construction according to the present invention with the resilient insert construction being shown in a relaxed configuration, and a fragmentary container construction with contained beverage to show relative positions of the lid-insert combination and container construction after assembly in a first angled position, the contained beverage having a horizontal beverage surface angled at the first angled position relative to the lid top of the lid construction to allow contained beverage to permeate apertures formed in the resilient insert construction.

FIG. 10 is a diagrammatic cross-sectional third sequential side view depiction of the first alternative assembled lid-insert combination and container construction according to the present invention with the resilient insert construction being shown in a relaxed configuration, and a fragmentary container construction with contained beverage to show relative positions of the lid-insert combination and container construction after assembly again in an upright position, the contained beverage having a horizontal beverage surface parallel to the lid top of the lid construction to allow aperture-permeated beverage to pool upon the concave surface of the insert construction relative to the lid top at a beverage-pooling zone.

FIG. 11 is a diagrammatic cross-sectional fourth sequential side view depiction of the first alternative assembled lid-insert combination and container construction according to the present invention with the resilient insert construction being shown in a relaxed configuration, and a fragmentary container construction with contained beverage to show relative positions of the lid-insert combination and container construction after assembly in a second angled position, the contained beverage having a horizontal beverage surface angled relative to the lid top of the lid construction in the second angled position to allow aperture-permeated beverage to outlet through a primary beverage outlet aperture formed in the lid construction.

FIG. 12 is an exploded first sequential side view of a first series of first alternative lid-insert combinations according to the present invention, each of which lid-insert combinations is depicted with a longitudinal cross-section of the lid-insert combination showing the resilient insert construction of the lid-insert combination in the relaxed configuration just prior to being arranged in an uncompressed, or freely stacked formation.

FIG. 13 is a second sequential side view of the first series of first alternative lid-insert combinations according to the present invention otherwise depicted in FIG. 12 just after being arranged in an uncompressed, freely stacked formation.

FIG. 14 is a third sequential side view of the first series of first alternative lid-insert combinations according to the present invention otherwise depicted in FIG. 13 just after being compressed while in stacked formation, the insert constructions being reconfigured by the stacked compression into the actuated configuration, the stacked formation being actuably stacked by the stacked compression.

FIG. 15 is a fourth sequential side view of the first series of first alternative lid-insert combinations and a second series of first alternative lid-insert combinations added to said first series just after being compressed while in stacked formation, the insert constructions being reconfigured by the stacked compression into the actuated configuration, the stacked formation being actuably stacked by the stacked compression.

FIG. 16 is a fifth sequential side view of the first series of first alternative lid-insert combinations, the second series of first alternative lid-insert combinations, and a third series of first alternative lid-insert combinations added to said first and second series just after being compressed while in stacked formation, the insert constructions being reconfigured by the stacked compression into an actuated stacked column formation, the actuated stacked column formation being actuably stacked by the stacked compression and held in the actuably stacked configuration by a column-enclosing sheath construction.

FIG. 17 is a sixth sequential side view of the first through third series of lid-insert combinations, as enclosed within the column-enclosing sheath as packaged with a series of identically actuated stacked column formations, the right most stacked column formation having its column-enclosing sheath pierced thereby decompressing the otherwise actuably stacked column formation, the decompressed stacked column formation gaining in relative stacked height relative to the actuated stacked column formations.

FIG. 18 is an enlarged cross-sectional depiction of a first preferred unibody (i.e. integrally formed or permanently attached) lid-membrane combination according to the present invention showing the membrane portion of the unibody lid-membrane combination in a first, actuated or non-relaxed configuration, the membrane portion being concave relative to the lid bottom or lid mouth.

FIG. 19 is an enlarged cross-sectional depiction of the first preferred unibody (i.e. integrally formed or permanently attached) lid-membrane combination according to the present invention showing the membrane portion of the unibody lid-membrane combination in a second relaxed configuration, the membrane portion being convex relative to the lid bottom or lid mouth.

FIG. 20 is an enlarged cross-sectional depiction of a second preferred unibody (i.e. integrally formed or permanently attached) lid-membrane combination according to the present invention showing the membrane portion of the unibody lid-membrane combination in a first, actuated or non-relaxed configuration, the membrane portion comprising an inverted convex ring or ridge relative to the lid bottom or lid mouth with an area of centralized concavity in the trough section central to the convex ridge.

FIG. 21 is an enlarged cross-sectional depiction of the second preferred unibody (i.e. integrally formed or permanently attached) lid-membrane combination according to the present invention showing the membrane portion of the unibody lid-membrane combination in a second relaxed configuration, the entire membrane portion being convex relative to the lid bottom or lid mouth.

FIG. 22 is a first enlarged cross-sectional depiction of an alternative unibody (i.e. integrally formed or permanently attached) lid-spring combination according to the present invention showing the spring portion of the unibody lid-spring combination in a first, actuated or non-relaxed configuration, the spring portion being spring actuated towards the lid top such that the radially inner spring terminus is coplanar with the lid top.

FIG. 23 is a second enlarged cross-sectional depiction of the alternative unibody (i.e. integrally formed or permanently attached) lid-spring combination according to the present invention showing the spring portion of the unibody lid-spring combination in a second relaxed configuration, the spring portion being relaxed and extending obliquely relatively to the lid top.

FIG. 24 is a transverse cross-sectional, diagrammatic type depiction as sectioned from FIG. 25 of the second preferred unibody (i.e. integrally formed or permanently attached) lid-membrane combination according to the present invention showing the membrane portion of the unibody lid-membrane combination while in a relaxed configuration with pooled beverage being pooled centrally circular within a beverage-pooling zone according to the present invention and beverage-letting apertures extending in lateral or peripheral adjacency to the primary beverage outlet.

FIG. 25 is an enlarged, longitudinal cross-sectional depiction of the second preferred unibody (i.e. integrally formed or permanently attached) lid-membrane combination according to the present invention attached to a fragmentary container containing beverage showing the membrane portion of the unibody lid-membrane combination in a relaxed configuration with pooled beverage being pooled centrally within a beverage-pooling zone according to the present invention.

FIG. 26 is a diagrammatic cross-sectional first sequential side view depiction of the second preferred unibody (i.e. integrally formed or permanently attached) lid-membrane combination according to the present invention attached to a fragmentary container containing beverage and showing the membrane portion of the unibody lid-membrane combination in a relaxed configuration to show relative positions of the lid-insert combination and container construction after assembly in an upright position, the contained beverage having a horizontal beverage surface parallel to the a lid top of the lid construction.

FIG. 27 is a diagrammatic cross-sectional second sequential side view depiction of the second preferred unibody (i.e. integrally formed or permanently attached) lid-membrane combination according to the present invention attached to a fragmentary container containing beverage and showing the membrane portion of the unibody lid-membrane combination in a relaxed configuration to show relative positions of the lid-insert combination and container construction after assembly in a first angled position, the contained beverage having a horizontal beverage surface angled at the first angled position relative to the lid top of the lid construction to allow contained beverage to permeate apertures formed in the resilient insert or membrane construction.

FIG. 28 is a diagrammatic cross-sectional third sequential side view depiction of the second preferred unibody (i.e. integrally formed or permanently attached) lid-membrane combination according to the present invention attached to a fragmentary container containing beverage and showing the membrane portion of the unibody lid-membrane combination in a relaxed configuration to show relative positions of the lid-insert combination and container construction after assembly again in an upright position, the contained beverage having a horizontal beverage surface parallel to the lid top of the lid construction to allow aperture-permeated beverage to pool upon the concave surface of the insert or membrane construction relative to the lid top at a beverage-pooling zone.

FIG. 29 is a diagrammatic cross-sectional fourth sequential side view depiction of the second preferred unibody (i.e. integrally formed or permanently attached) lid-membrane combination according to the present invention attached to a fragmentary container containing beverage and showing the membrane portion of the unibody lid-membrane combination in a relaxed configuration to show relative positions of the lid-insert combination and container construction after assembly in a second angled position, the contained beverage having a horizontal beverage surface angled relative to the lid top of the lid construction in the second angled position to allow aperture-permeated beverage to outlet through a primary beverage outlet aperture formed in the lid construction.

FIG. 30 is a transverse cross-sectional, diagrammatic type depiction as sectioned from FIG. 31 of a third preferred unibody (i.e. integrally formed or permanently attached) lid-membrane combination according to the present invention showing the membrane portion of the unibody lid-membrane combination while in an upwardly arched configuration with pooled beverage being pooled radially peripherally within a beverage-pooling zone according to the present invention and beverage-letting apertures extending in lateral or peripheral adjacency to the primary beverage outlet.

FIG. 31 is an enlarged, longitudinal cross-sectional depiction of the third preferred unibody (i.e. integrally formed or permanently attached) lid-membrane combination according to the present invention attached to a fragmentary container containing beverage showing the membrane portion of the unibody lid-membrane combination in an upwardly arched configuration with pooled beverage being pooled radially peripherally within a beverage-pooling zone according to the present invention.

FIG. 32 is a diagrammatic cross-sectional first sequential side view depiction of the third preferred unibody (i.e. integrally formed or permanently attached) lid-membrane combination according to the present invention attached to a fragmentary container containing beverage and showing the membrane portion of the unibody lid-membrane combination in an upwardly arched configuration to show relative positions of the lid-insert combination and container construction after assembly in an upright position, the contained beverage having a horizontal beverage surface parallel to the a lid top of the lid construction.

FIG. 33 is a diagrammatic cross-sectional second sequential side view depiction of the third preferred unibody (i.e. integrally formed or permanently attached) lid-membrane combination according to the present invention attached to a fragmentary container containing beverage and showing the membrane portion of the unibody lid-membrane combination in an upwardly arched configuration to show relative positions of the lid-insert combination and container construction after assembly in a first angled position, the contained beverage having a horizontal beverage surface angled at the first angled position relative to the lid top of the lid construction to allow contained beverage to permeate apertures formed in the resilient insert or membrane construction.

FIG. 34 is a diagrammatic cross-sectional third sequential side view depiction of the third preferred unibody (i.e. integrally formed or permanently attached) lid-membrane combination according to the present invention attached to a fragmentary container containing beverage and showing the membrane portion of the unibody lid-membrane combination in an upwardly arched configuration to show relative positions of the lid-insert combination and container construction after assembly again in an upright position, the contained beverage having a horizontal beverage surface parallel to the lid top of the lid construction to allow aperture-permeated beverage to pool upon the upwardly arched surface of the insert or membrane construction relative to the lid top at an annular beverage-pooling zone.

FIG. 35 is a diagrammatic cross-sectional fourth sequential side view depiction of the third preferred unibody (i.e. integrally formed or permanently attached) lid-membrane combination according to the present invention attached to a fragmentary container containing beverage and showing the membrane portion of the unibody lid-membrane combination in an upwardly arched configuration to show relative positions of the lid-insert combination and container construction after assembly in a second angled position, the contained beverage having a horizontal beverage surface angled relative to the lid top of the lid construction in the second angled position to allow aperture-permeated beverage to outlet through a primary beverage outlet aperture formed in the lid construction.

FIG. 36 is a transverse cross-sectional, diagrammatic type depiction as sectioned from FIG. 37 of a fourth preferred unibody (i.e. integrally formed or permanently attached) lid-membrane combination according to the present invention showing the membrane portion of the unibody lid-membrane combination while in a downwardly arched, relaxed configuration with pooled beverage being pooled centrally circular within a beverage-pooling zone according to the present invention and a single beverage-letting aperture being formed therein circumferentially opposite the primary beverage outlet.

FIG. 37 is an enlarged, longitudinal cross-sectional depiction of the fourth preferred unibody (i.e. integrally formed or permanently attached) lid-membrane combination according to the present invention attached to a fragmentary container containing beverage showing the membrane portion of the unibody lid-membrane combination in an downwardly arched, relaxed configuration with pooled beverage being pooled centrally within a beverage-pooling zone according to the present invention.

FIG. 38 is a diagrammatic cross-sectional first sequential side view depiction of the fourth preferred unibody (i.e. integrally formed or permanently attached) lid-membrane combination according to the present invention attached to a fragmentary container containing beverage and showing the membrane portion of the unibody lid-membrane combination in a downwardly arched, relaxed configuration to show relative positions of the lid-insert combination and container construction after assembly in an upright position, the contained beverage having a horizontal beverage surface parallel to the a lid top of the lid construction.

FIG. 39 is a diagrammatic cross-sectional second sequential side view depiction of the fourth preferred unibody (i.e. integrally formed or permanently attached) lid-membrane combination according to the present invention attached to a fragmentary container containing beverage and showing the membrane portion of the unibody lid-membrane combination in a downwardly arched, relaxed configuration to show relative positions of the lid-insert combination and container construction after assembly in a first angled position, the contained beverage having a horizontal beverage surface angled at the first angled position relative to the lid top of the lid construction to allow contained beverage to permeate the aperture formed in the resilient insert or membrane construction.

FIG. 40 is a diagrammatic cross-sectional third sequential side view depiction of the fourth preferred unibody (i.e. integrally formed or permanently attached) lid-membrane combination according to the present invention attached to a fragmentary container containing beverage and showing the membrane portion of the unibody lid-membrane combination in a downwardly arched, relaxed configuration to show relative positions of the lid-insert combination and container construction after assembly again in an upright position, the contained beverage having a horizontal beverage surface parallel to the lid top of the lid construction to allow aperture-permeated beverage to pool upon the downwardly arched surface of the insert or membrane construction relative to the lid top at a central beverage-pooling zone.

FIG. 41 is a diagrammatic cross-sectional fourth sequential side view depiction of the fourth preferred unibody (i.e. integrally formed or permanently attached) lid-membrane combination according to the present invention attached to a fragmentary container containing beverage and showing the membrane portion of the unibody lid-membrane combination in a downwardly arched, relaxed configuration to show relative positions of the lid-insert combination and container construction after assembly in a second angled position, the contained beverage having a horizontal beverage surface angled relative to the lid top of the lid construction in the second angled position to allow aperture-permeated beverage to outlet through a primary beverage outlet aperture formed in the lid construction.

FIG. 42 is a diagrammatic cross-sectional first sequential side view depiction of a fifth preferred lid-membrane combination according to the present invention attached to a fragmentary container construction containing beverage and showing the membrane portion of the lid-membrane combination defining a peripheral, annular beverage-pooling compartment to show relative positions of the lid-insert combination and container construction after assembly in an upright position, the contained beverage having a horizontal beverage surface parallel to the a lid top of the lid construction.

FIG. 43 is a diagrammatic cross-sectional second sequential side view depiction of the fifth preferred lid-membrane combination according to the present invention attached to a fragmentary container construction containing beverage and showing the membrane portion of the lid-membrane combination defining a peripheral, annular beverage-pooling compartment to show relative positions of the lid-insert combination and container construction after assembly in a first angled position, the contained beverage having a horizontal beverage surface angled at the first angled position relative to the lid top of the lid construction to allow contained beverage to permeate the apertures formed in the insert or membrane construction.

FIG. 44 is a diagrammatic cross-sectional third sequential side view depiction of the fifth preferred lid-membrane combination according to the present invention attached to a fragmentary container construction containing beverage and showing the membrane portion of the lid-membrane combination defining a peripheral, annular beverage-pooling compartment to show relative positions of the lid-insert combination and container construction after assembly again in an upright position, the contained beverage having a horizontal beverage surface parallel to the lid top of the lid construction to allow aperture-permeated beverage to pool within the peripheral, annular beverage-pooling compartment defined by the insert or membrane construction.

FIG. 45 is a diagrammatic cross-sectional fourth sequential side view depiction of the fifth preferred lid-membrane combination according to the present invention attached to a fragmentary container construction containing beverage and showing the membrane portion of the lid-membrane combination defining a peripheral, annular beverage-pooling compartment to show relative positions of the lid-insert combination and container construction after assembly in a second angled position, the contained beverage having a horizontal beverage surface angled relative to the lid top of the lid construction in the second angled position to allow aperture-permeated beverage to outlet through a primary beverage outlet aperture formed in the lid construction.

FIG. 46 is an enlarged depiction of the structures otherwise depicted in FIG. 42, enlarged for purpose of presenting greater clarity of the structures depicted.

FIG. 47 is an enlarged depiction of the structures otherwise depicted in FIG. 43, enlarged for purpose of presenting greater clarity of the structures depicted.

FIG. 48 is an enlarged depiction of the structures otherwise depicted in FIG. 44, enlarged for purpose of presenting greater clarity of the structures depicted.

FIG. 49 is an enlarged depiction of the structures otherwise depicted in FIG. 45, enlarged for purpose of presenting greater clarity of the structures depicted.

FIG. 50 is a transverse cross-sectional, diagrammatic type depiction as sectioned from FIG. 51 of the fifth preferred lid-membrane combination according to the present invention showing the membrane portion of the lid-membrane combination defining a peripheral, annular beverage-pooling compartment showing pooled beverage being pooled peripherally or annularly within an annular beverage-pooling zone according to the present invention with radially directed heat transfer via the lid wall of the lid construction.

FIG. 51 is an enlarged, longitudinal cross-sectional depiction of the fifth preferred lid-membrane combination according to the present invention attached to a fragmentary container construction containing beverage showing the membrane portion of the lid-membrane combination defining a peripheral, annular beverage-pooling compartment with compartment-pooled beverage being pooled peripherally or annularly within an annular beverage-pooling zone according to the present invention.

FIG. 52 is a transverse cross-sectional, diagrammatic type depiction as sectioned from FIG. 53 of a modified fifth preferred lid-membrane combination according to the present invention showing the membrane portion of the lid-membrane combination defining a peripheral, annular beverage-pooling compartment showing pooled beverage being pooled peripherally or annularly within an annular beverage-pooling zone according to the present invention with radially directed heat transfer via the lid wall of the lid construction.

FIG. 53 is an enlarged, longitudinal cross-sectional depiction of the modified fifth preferred lid-membrane combination according to the present invention attached to a fragmentary container construction containing beverage showing the membrane portion of the lid-membrane combination defining a peripheral, annular beverage-pooling compartment with compartment-pooled beverage being pooled peripherally or annularly within an annular beverage-pooling zone according to the present invention.

FIG. 54 is an enlarged, exploded longitudinal cross-sectional depiction of the fifth preferred lid-membrane combination according to the present invention depicting from bottom to top (1) a fragmentary container construction containing beverage, (2) the membrane portion of the lid-membrane combination, and (3) a lid construction according to the present invention.

FIG. 55 is an enlarged, exploded longitudinal cross-sectional depiction of the lid construction of the fifth preferred lid-membrane combination according to the present invention.

FIG. 56 is an enlarged, exploded longitudinal cross-sectional depiction of the membrane construction of the fifth preferred lid-membrane combination according to the present invention.

### DETAILED DESCRIPTION OF THE PREFERRED EMBODIMENTS AND ASSOCIATED METHODOLOGY

Referring now to the drawings with more specificity, the preferred embodiments of the present invention primarily concern a (hot) beverage container lid-insert combination or lid construction for enabling a user/drinker to effectively transfer heat (as generically referenced at 100) from a relatively hot assembly-contained beverage 101 so as to cool the beverage 101 before it enters the user's/drinker's mouth. The present invention is thus contemplated to provide certain low-cost, disposable means for transferring thermal energy from a relatively hot liquid beverage 101 to relatively cool surroundings so as to prevent spillage primarily and/or scalding secondarily, and to further increase rigidity of the lid construction.

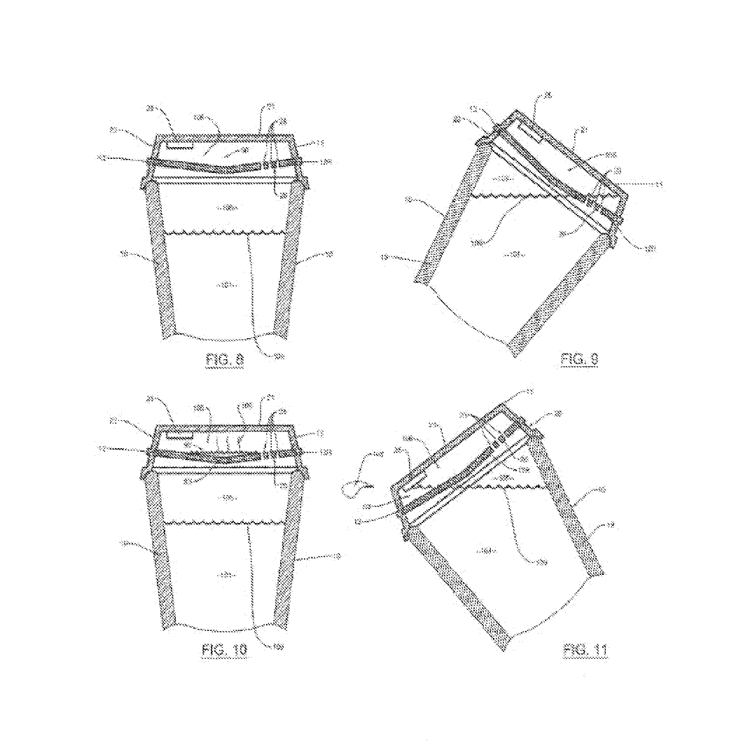

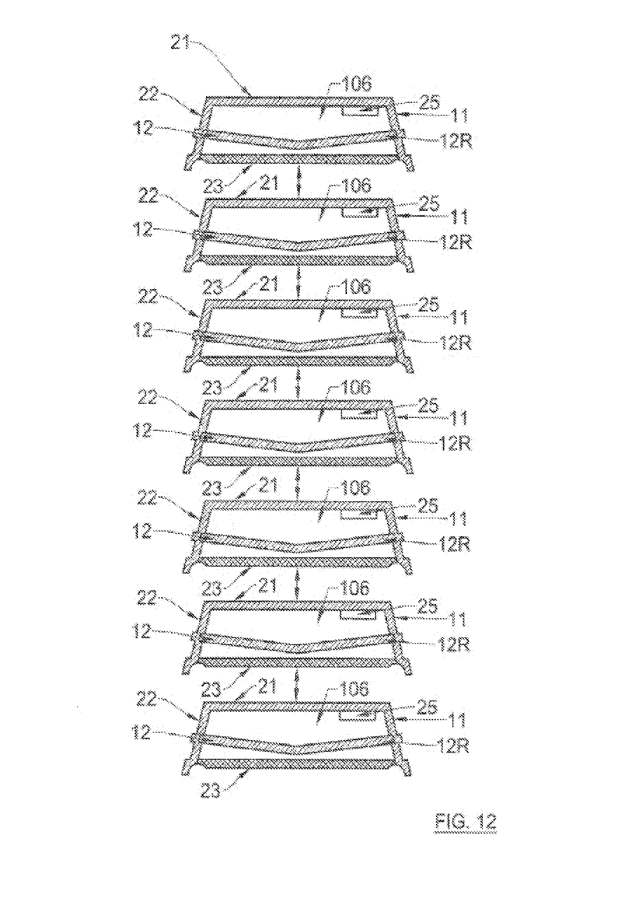

When viewed in combination with a hot beverage container assembly, the present invention is believed to comprise a container structure as at 10, a lid structure or construction as at 11, and an insert structure or membrane construction as generally depicted and referenced at 12. The insert or membrane construction 12 according to the present invention is preferably constructed from a resilient material and thus may have either (1) a relaxed configuration as generally depicted in FIGS. 2, 5, 6, 8-13, and 17 as at 12R, or (2) an actuated configuration as generally depicted in FIGS. 1, 7, 14, 15, 16, and 17 at 12A.

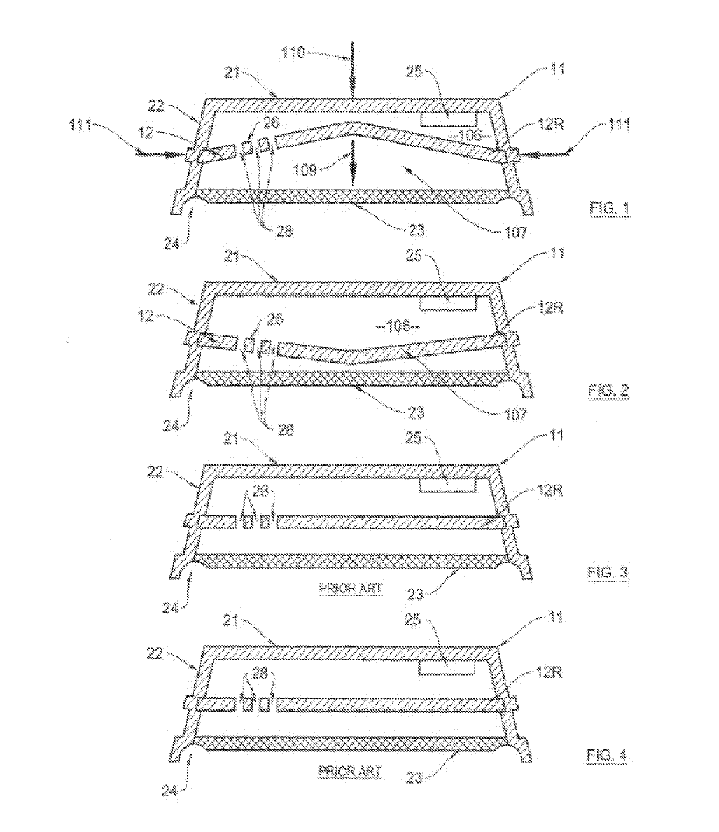

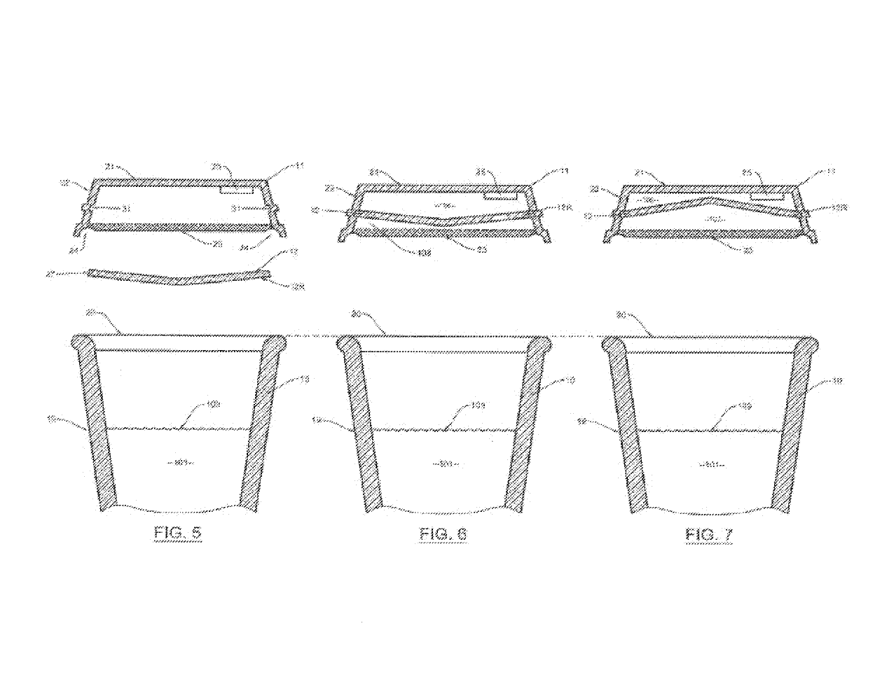

FIGS. 3 and 4 depict a PRIOR ART first lid structure or construction 11, and a second lid PRIOR ART structure or construction as at 13. Certain PRIOR ART insert structures or constructions are shown referenced at 14 in FIGS. 3 and 4 for comparative purposes to the insert construction 12 as depicted in actuated and relaxed configurations 12A and 12R respectively in FIGS. 1 and 2. The reader will note that the insert structures 14 are substantially planar in configuration, whereas the actuated insert construction 12A is concave relative to the lid bottom or lid mouth or lower lid rim as at 23 (or concave relative to the lid top 21), and the relaxed insert construction 12R is convex relative the lower lid rim 23 (or convex relative to the lid top 21).

The essential container structure 10 is believed to preferably comprise a container bottom, a container wall as at 19, and an upper container rim as at 20. The upper container rim 20 has a rim perimeter, which rim perimeter preferably extends in a rim plane as generally referenced at 102. The lid structure or construction 11 is believed to preferably comprise a lid top 21, a lid wall 22, and a lower lid rim 23 having a container rim-receiving groove 24. Thus, the lower lid rim 23 receives or is otherwise attachable or cooperable with the upper container rim 20 as generally depicted in FIGS. 8-11.

The lid top 21 comprises a primary beverage outlet as at 25, which primary beverage outlet 25 may be of various sizes and configurations. It is contemplated, for example, that the primary beverage outlet 25 may be circular of differing diameters. Other outlet shapes are contemplated, however, such as oval outlets or generally rectangular outlets. The size and shape of the primary outlet 25 is not believed critical to the practice of the present invention, although it is noted that larger primary outlets 25 tend to outlet beverage flow (as at 103) at a greater rate and thus may more readily subject users/drinkers to scalding should the assembly-contained beverage 101 be injuriously hot. The present invention is thus believed particularly designed for lid structures 11 having relatively large primary beverage outlets 25.

Central to the practice of the present invention is the resilient insert construction 12 of the lid-insert combination or lid construction. The insert structure or construction 12 preferably provides a beverage-damming structure or portion as at 26, an outer rim-engaging structure or periphery as at 27, and a beverage-pooling structure or portion 90, which portion 90 changes depending on whether the insert construction is in a relaxed or actuated configuration. The insert or membrane construction 12 is contemplated to be preferably formed from an elastic or resilient, thermally-insulative, food-grade, and heat-resistant material.

In this last regard, it is contemplated that the material should undergo minimal or minimized structural/dimensional changes when heat 100 is transferred into the material. The insert structure or membrane construction 12 is preferably sized and shaped for receipt within the rim perimeter and, being received, may be alternatively removably attached thereto, permanently attached thereto, or integrally formed therewith. The insert structure or membrane construction 12 and analogous structures 51 and/or 61 preferably extend in either a concave or convex manner relative to the rim plane 102 as generally depicted in FIGS. 6 and 7. The relaxed configuration 12R is primarily a “for beverage use” configuration and the actuated configuration 12A is primarily a “for packaging use” configuration.

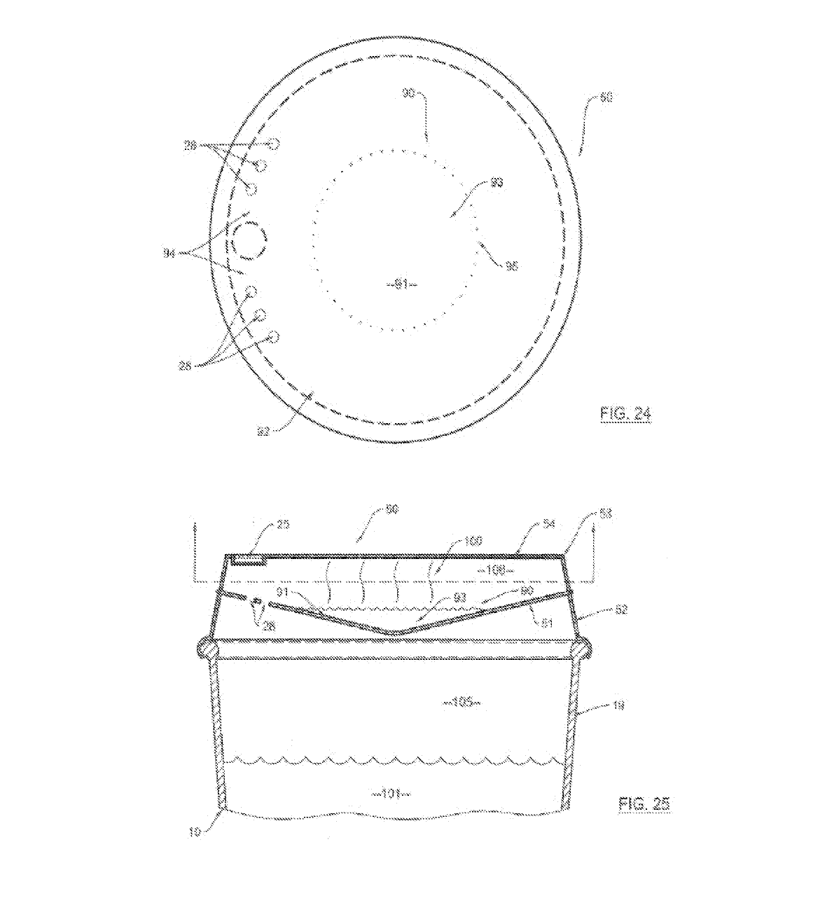

In other words, the present invention provides a hot beverage container insert construction 12 or lid construction having a resilient inner membrane that is actuable or biasable intermediate two configurations, a first of which configurations is depicted as at 12A designed for packaging purposes, and a second of which configurations is depicted as at 12R designed for the basic purposes set forth in issued U.S. Pat. No. 8,459,491 (the '491 patent), the specifications of which were authored by the same inventor as these specifications. The present invention, however, provides an additional beverage-pooling zone or portion as at 90, which beverage-pooling zone 90 may be either centrally circular as at 91 in FIG. 24, or centrically annular or radially peripherally as at 92 in FIG. 25 depending on the bowed configuration of the insert or membrane construction 12 into which zone 90 the pooled beverage 93 pools. A radially outer water line 95 is depicted with a dotted line for the centrally circular zone 91, and a radially inner water line 96 is depicted with a dotted line for the annular zone 92.

The “for packaging use” or actuated configuration 12A of the container-lid insert or membrane construction 12 involves a configuration that effectively tucks or displaces the body of the insert or membrane construction 12 deeper into the lid construction 11 or 13 or toward the lid top 21 such that additional or maximized space is created between the concavity of the insert or membrane construction 12 and the lower lid rim 23 in the space referenced at 107. By comparison, the space referenced at 108 (i.e. that space between the convexity and the lower lid rim 23) when the insert or membrane construction 12 is in the relaxed configuration 12R is minimized.

The container-lid insert or membrane construction 12 is thus preferably formed from a resilient material that is arcuate or bowed upwardly in cross-section toward the lid top 21 when in the actuated or packaging use configuration as generally and comparatively depicted in FIGS. 1, 7, and 14-17, and when slightly forced or released from its actuated configuration 12A, reverts to its relaxed configuration under the spring-restorative forces inherent to the material toward (as at vector 109) the relaxed configuration 12R.

The insert or membrane construction 12 thus preferably provides a “pop-up” or “pop-down” type container-lid insert or membrane construction 12 that preferably makes a popping sound as it progresses from the actuated state 12A into the relaxed state 12R under one of two basic mechanisms. The first method of popping the insert or membrane construction 12 from the actuated configuration 12A to the relaxed configuration 12R is achieved by manually pressing the lid construction 11 or 13 from one of a select number of directions. For example, the insert or membrane construction 12 may be popped from the actuated state 12A either by pressing against the insert-outfitted lid construction 11 or 13 in a radial direction as at vectors 110 as depicted in FIG. 1, or by pressing against the insert-outfitted lid construction 11 or 13 in an axial direction as at vector 111 as also depicted in FIG. 1.

The actions of manually pressing against select portions of the insert-outfitted lid construction 11 or 13 may well operate to transfer sufficient force into the actuably biased container-lid insert or membrane construction 12 to release the actuated insert or membrane construction 12 from its actuated configuration 12A and bring it back to its relaxed configuration 12R under action of the spring-like restorative forces inherent to the material construction thereof.

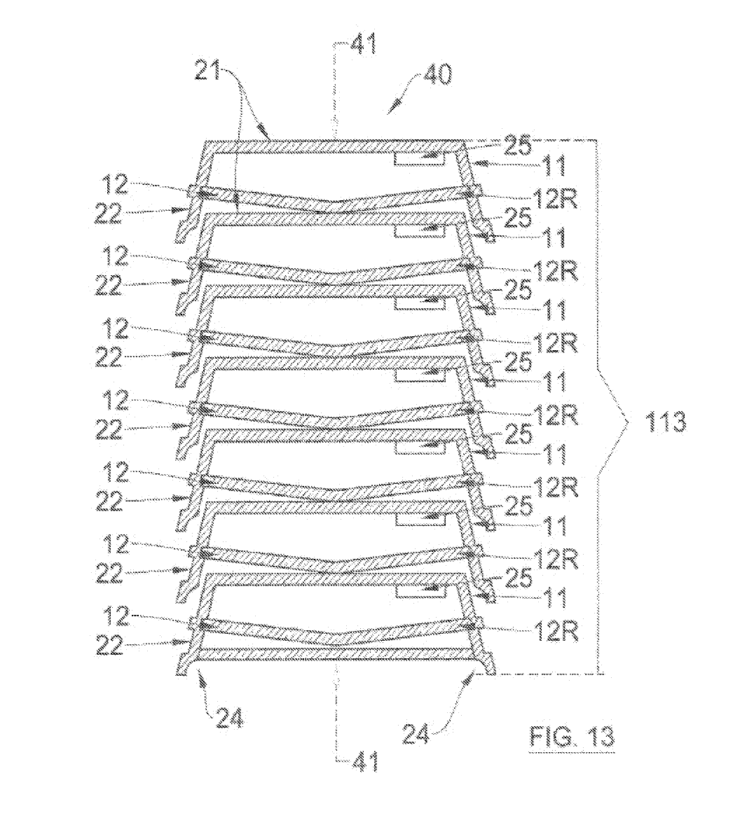

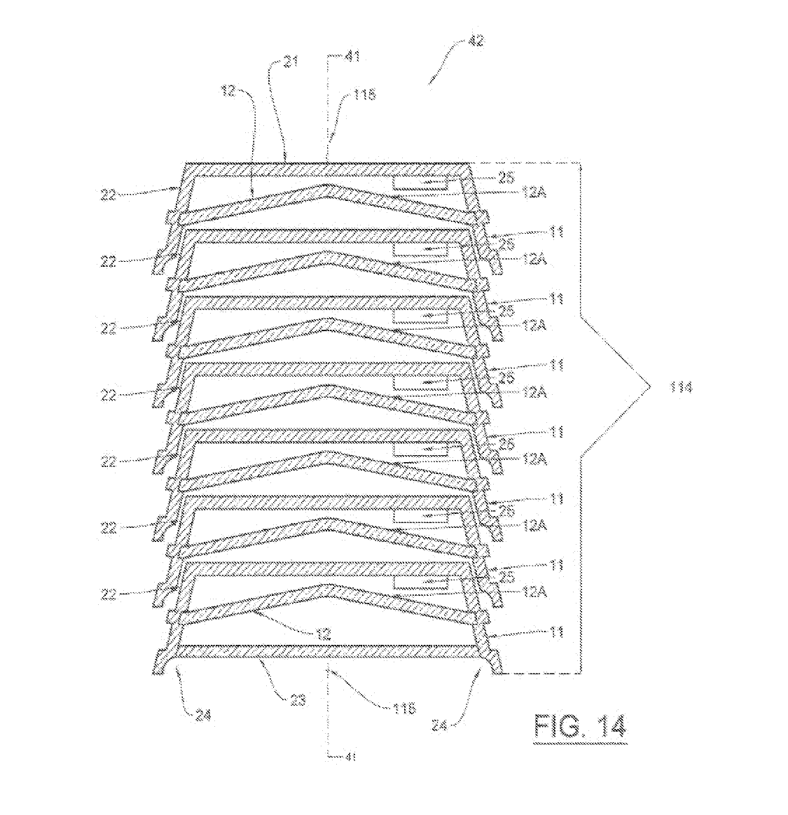

A second method of releasing the insert or membrane construction 12 from the actuated configuration 12A to the relaxed configuration 12R is by action of certain packaging methods. In this regard, the reader is directed to FIGS. 12-17. FIG. 12 is an exploded first sequential side view of a first series of axially aligned alternative lid-insert combinations according to the present invention, each of which lid-insert combinations is depicted with a longitudinal cross-section of the lid-insert combination showing the resilient insert or membrane construction 12 of the lid-insert combination in the relaxed configuration just prior to being arranged in an uncompressed, stacked formation. By contrast, FIG. 13 is a second sequential side view of the first series of lid-insert combinations just after being arranged in an uncompressed, freely stacked formation as at 40.

Referencing FIG. 13, the reader will note that the lid tops 21 engage the insert or membrane construction 12 when in the stacked configuration or formation 40 roughly at the stacked formation axis 41. The lid tops 21 of lid constructions 11 thus provide potential force transfers into the resilient insert or membrane construction 12 from below when in the stacked formation 40. Formation compression force(s) as at vectors 112 may be axially directed into the formation 40 to compress the compression spring-like stacked formation 40.

FIG. 14 is a third sequential side view of the first series of alternative lid-insert combinations just after being compressed via forces 112 while in the stacked formation 40. From a comparative inspection of FIG. 13 versus FIG. 14, the reader will note that the insert or membrane constructions 12 are reconfigured from the relaxed configuration 12R to the actuated configuration 12A by the action of compressing the stacked formation 40 into an actuated stacked formation 42. In other words, the uncompressed stacked formation 40 becomes being actuably stacked by compressing the stacked formation 40.

The reader should note the difference in formation height 113 of the uncompressed stacked formation 40 versus the formation height 114 of the compressed stacked formation 42. The relative decrease in formation height or difference in formation height between height 114 and height 113 is significant and basically achieved by the resilient reconfiguration of the insert construction 12 from the relaxed configuration 12R (with the inherent minimized space 108) to the actuated configuration 12A (with the maximized space 107). Note that certain force as at vectors 115 hold or retain the compressed stacked formation 42 in a compressed state.

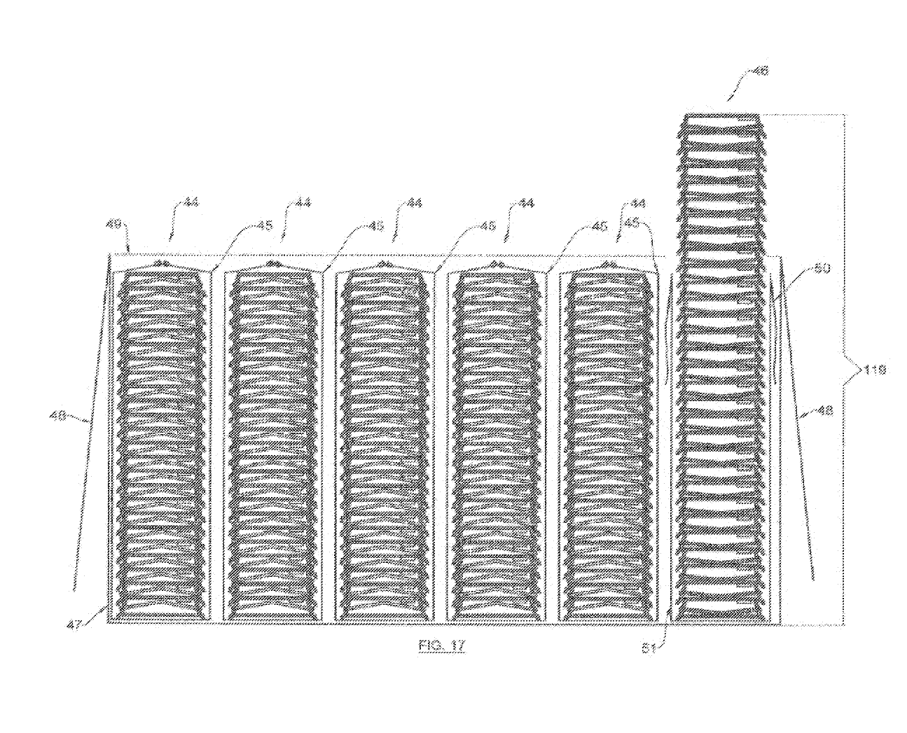

Given that the volume of a cylinder may be defined as a function of its height as per the equation V=r h, where “V” is the volume of the cylinder; “r” is the radius of the cylinder; and “h” is the height of the cylinder, the reader will note that the action of resilient insert or membrane construction 12 operates to enable a volumetric reduction when moving from the uncompressed stacked columnar configuration as at 46 in FIG. 17 to the compressed, stacked columnar configuration generally depicted at 44 in FIG. 17.

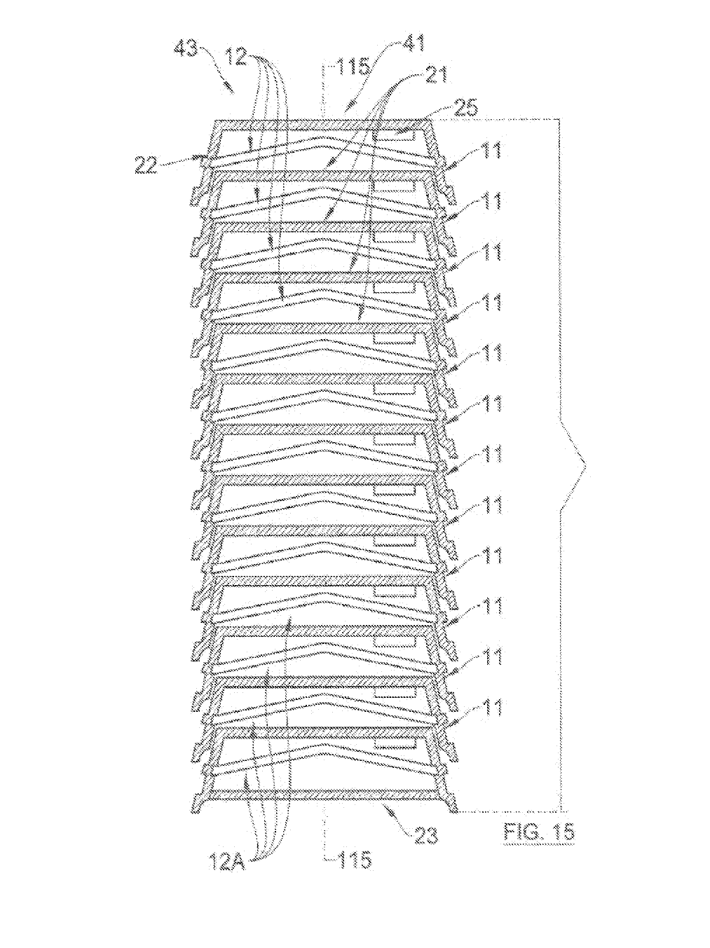

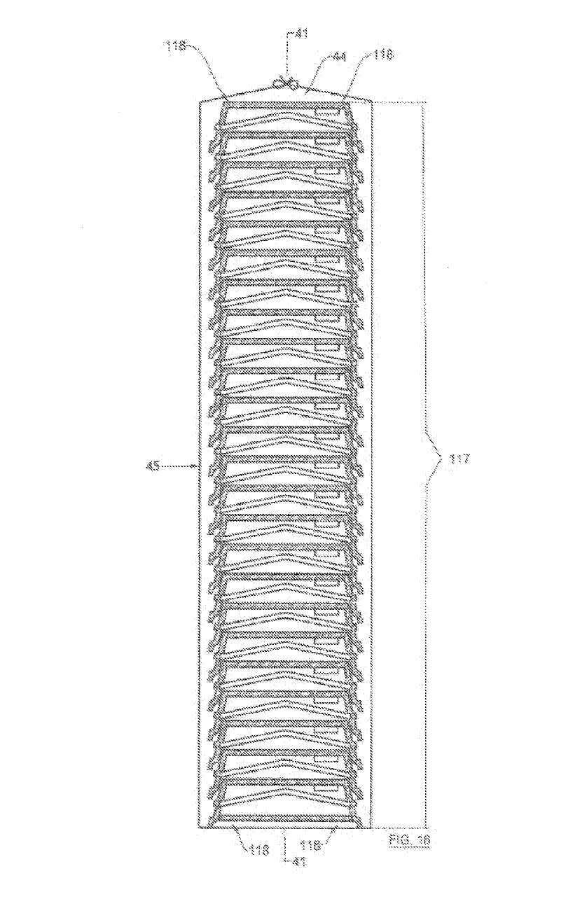

Referencing FIG. 15, the reader will there see a fourth sequential side view of the first series of lid-insert combinations and a second series of lid-insert combinations substantially identical to said first series, and added to said first series just after being compressed while in stacked formation. This addition of the second series of lid-insert combinations effectively doubles the formation height 114 to a formation height 116 and renders a new compressed stacked formation 43. Note again that certain force as at vectors 115 hold or retain the compressed stacked formation 43 in a compressed state.

FIG. 16 is a fifth sequential side view of the first series of lid-insert combinations, the second series of lid-insert combinations, and a third series of lid-insert combinations added to said first and second series just after being compressed while in stacked formation thereby forming the further stacked formation 44 earlier referenced having a doubled formation height 117 compared to formation height 116 of the stacked formation 43. The actuated stacked column formation 44 is actuably stacked by stacked compression and held in the actuably stacked configuration or formation by certain force maintenance means as exemplified by a column-enclosing sheath or sleeve construction 45. The sleeve construction 45 applies the compression forces 116 or forces 118 to maintain the stacked column formation 44 in a compressed state.

FIG. 17 is a sixth sequential side view of the first through third series of lid-insert combinations, in the stacked column formation 44 as enclosed within the column-enclosing sheath or sleeve 45, and as packaged with a series of identically actuated stacked column formations 44. The right most stacked column formation 46 has its column-enclosing sheath or sleeve 45 pierced thereby removing the forces 118, and decompressing the otherwise actuably stacked column formation 44. The decompressed stacked column formation 46 gains in relative stacked formation height 119 relative to the formation height 117 of the actuated stacked column formations 44.

The stacked columnar formations 44 and 46 are depicted as having been received in an open top box 47, which box comprises box top flaps as at 48, which when closed lie in plane box top plane 49. The column-enclosing sheath or sleeve of the decompressed stacked columnar formation 46 has been pierced and thus open ends 50 of the pierced sleeve 51 are also depicted alongside the decompressed stacked columnar formation 46. It is contemplated that the box 47 with its flaps 48 may operate as a back-up force maintenance means akin to forces 118 should the sheaths or sleeves 45 become pierced or otherwise damaged during transit.

It will thus be seen that the insert-outfitted container lid constructions 11 or 13 are stacked into nested columns, which nested columns naturally have some inherent spring characteristic of their own based on the collective resiliency of the resilient insert or membrane constructions 12 all actuated in the actuated configurations 12A. When in a compressed state, the columns and force maintenance means operate to keep the lid insert or membrane constructions 12 in the actuated configurations 12A. The columns would be maintained in the compressed state by virtue of certain packaging parameters or means (e.g. column-containing envelopes as at 45 or boxing as at 47 and exemplified by FIGS. 16 and 17).

When the force maintenance means are released from the columnar formations 44, the container lid insert or membrane constructions 12 may automatically return to their relaxed configurations 12R and the stacked columnar formations 44 become decompressed stacked columnar formations 46. In other words, the stacked columns return to a relaxed column configuration, and the individual container-lid assemblies return individually to the relaxed lid insert configuration(s) 12R.

This latter method of releasing the container-lid insert constructions 12 from the actuated or compressed column configuration to a relaxed column configuration is believed beneficial to the company employing the packaging method since workers, upon opening the packaging, are enabled to retrieve pre-relaxed insert-outfitted lid constructions direct from the packaging thus relieving the worker from wasting time and energy relaxing the lid insert assemblies under their own actions, or having to pull apart nested lid constructions since the lid construction according to the present invention are provided in a freely stacked configuration when in the uncompressed configuration.

With regard to the thermally insulative properties of the preferred material construction, it is contemplated that insert or membrane construction 12 may provide some modest heat-insulative properties by reflecting radiant heat 100 back towards assembly-contained beverage 101. In this regard, the beverage-opposing surface(s) of the insert or membrane construction 12 may be outfitted with a heat-reflective coating or material so as to effect a radiant barrier (e.g. a highly polished thin polymeric or metallic film).

It will be noted that the beverage-damming structure(s) 26 of lid structure 12 preferably comprises a series of apertures or cut-outs as generically referenced at 28. The series of apertures 28 primarily functions to outlet container-contained or lower compartment-contained beverage 101 from the beverage-containing, lower compartment 105 into the beverage-cooling, upper compartment 106. The beverage-cooling or upper compartment 106 receives heat 100 from the further compartmentalized or pooled beverage 93 thereby enabling the compartmentalized or pooled beverage 93 to cool before being further outlet (as at 103) via the primary beverage outlet 25.

The series of apertures 28 may secondarily function, however, to inlet air from the beverage-cooling, upper compartment 106 to the beverage-containing, lower compartment 105. The beverage-cooling, upper compartment 106 receives heat 100 from the compartmentalized or pooled beverage 93 thereby enabling the compartmentalized or pooled beverage 93 to cool before being further outlet via the primary beverage outlet 25. It is contemplated that the beverage-damming structure or beverage-pooling structure 26 slows the beverage rate of flow 103 so as to enable heat 100 transfer from the flow 103.

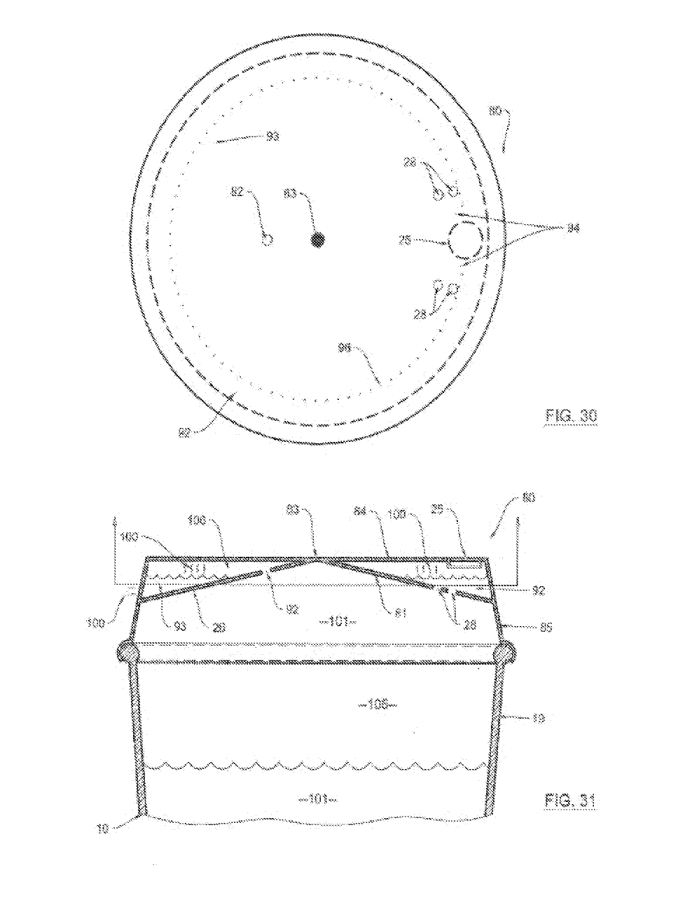

Comparatively referencing FIGS. 1, 2, and 8-11, 24 and 30, the reader will note that the apertures 28 may be either radially aligned as generally depicted in FIG. 30 or aligned peripherally as generally depicted in FIG. 24. In either arrangement, it will be further noted that the apertures 28 are laterally or peripherally spaced as at 94 from the primary beverage outlet 25 or circumferentially spaced opposite the outlet 25 as depicted in FIGS. 1, 2, and 8-11. The series of apertures 28 are preferably laterally or peripherally spaced as at 94 relative to the primary beverage outlet 25 so that the outlet 25 and apertures 28 are not aligned for diverting beverage flow and slowing flow from the primary beverage outlet 25 prior to consumption.

When the lid structure 11, container structure 10 and insert or membrane structure or construction 12 are assembled, the apertures 28 preferably extend inwardly or peripherally relative to the upper container rim 20 and the lower lid rim 23 for enabling the user to control beverage flow 103 rates via the series of apertures 28 by variously angling the beverage container assembly as for example by angling the assembly relative to the horizon or beverage surface 109 as is generally depicted in FIG. 9. A comparative inspection of the figures submitted in support of these specifications will illustrate for the reader that together the beverage-damming portion 26 outfitted with certain beverage-permeating means (as exemplified by apertures 28), operate to slow the beverage flow 103 rate for enabling heat 100 to transfer from the compartmentalized or pooled beverage 93 within the beverage-cooling compartment 106.

It is contemplated that the series of apertures 28 may be preferably aligned within the structure of the beverage-damming insert or membrane construction 12 and analogous structures 51/61 so as to provide a primary dam outlet for enabling incremental secondary beverage outlets (or beverage-permeating means) from the beverage-containing compartment 105 depending on the various angles of inclination thereof relative to the horizon or beverage surface 109.

An alternative embodiment to the preferred construction according to the present invention involves a lid structure specifically tailored to receive a beverage-damming structure. In this embodiment, certain structure-retaining means are formed in the lid structure so as to retain the beverage-damming, insert or membrane structure or construction 12. In this regard, the present invention further contemplates a beverage container lid assembly for outfitting a beverage container so as to enable a user to transfer heat 100 from a relatively hot assembly-contained beverage 101.

The alternative lid assembly comprises, in combination, a lid structure as variously depicted and referenced either at 11 or 13. The primary difference between lid structure 11 and lid structures 13 is that the lid wall 22 of lid structure 13 comprises certain inwardly extending dam-retaining means as exemplified by a bead or inner flange 30 whereas the lid structure 11 comprises a groove 31. It is contemplated, for example, that the dam-retaining means of lid structure 11 may be exemplified by a dam-receiving groove as depicted and referenced at 31, as is depicted in all the FIGS, except for FIG. 4, which latter figure depicts the bead or inner flange 30.

It is contemplated, for example that the insert or membrane construction 12 could be formed into a circular shape having a certain diameter and that the transverse cross-section of the lid wall 22 would comprise the groove 31 having a diameter slightly larger in magnitude relative to the diameter of the insert construction 12 so as to receive the insert construction 12. Given a certain structural thickness for the insert or membrane construction 12, it is contemplated that the groove 31 will have a slightly greater edge-receiving thickness so as to receive the thickness of the insert or membrane construction 12.

It is further contemplated that the dam-retaining means of lid insert or membrane structure 12 may be exemplified by a dam-receiving or dam-retaining flange 30. If, for example, the insert or membrane construction 12 were to be formed into the shape of a circle having a certain diameter and that the transverse cross-section of the lid wall 22 would comprise a dam-retaining flange or bead as at 30 having a diameter slightly lesser in magnitude relative to the diameter of the insert construction 12 so as to retain the insert or membrane construction 12 intermediate the bead 20 and the sloped angle of the wall 22.

It is further contemplated that the bead 30 or the bead-like structure may be discontinuous. That is to say, the bead-like structure may not extend the entire periphery of the inner wall 22. In this regard, it is contemplated a series of circumferentially-spaced dam-retaining beads or protrusions (not specifically illustrated) could also extend radially inwardly from the lid wall 22 for retaining the insert or membrane construction 12 in assembled relation with the lid structure as at 13.

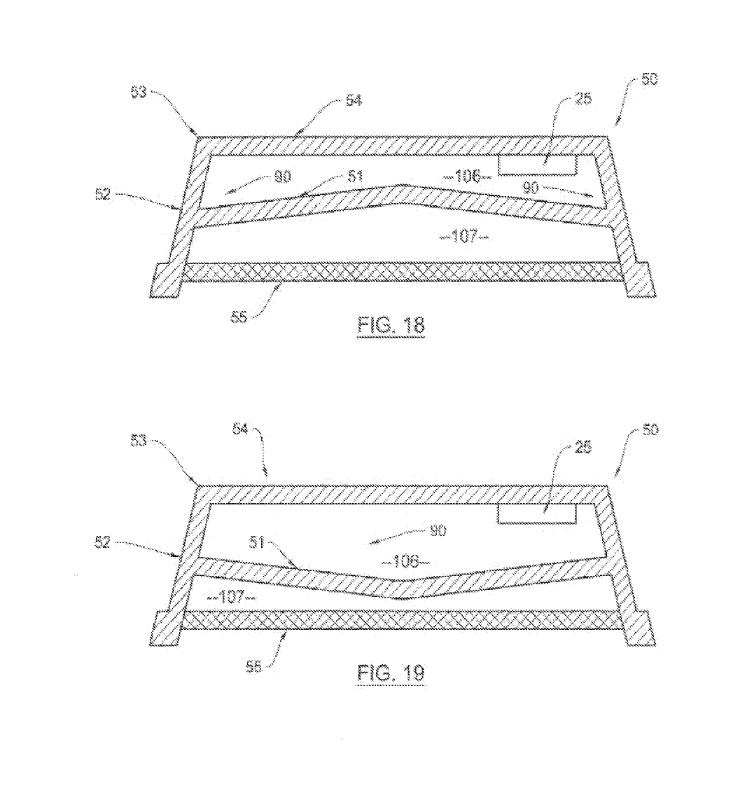

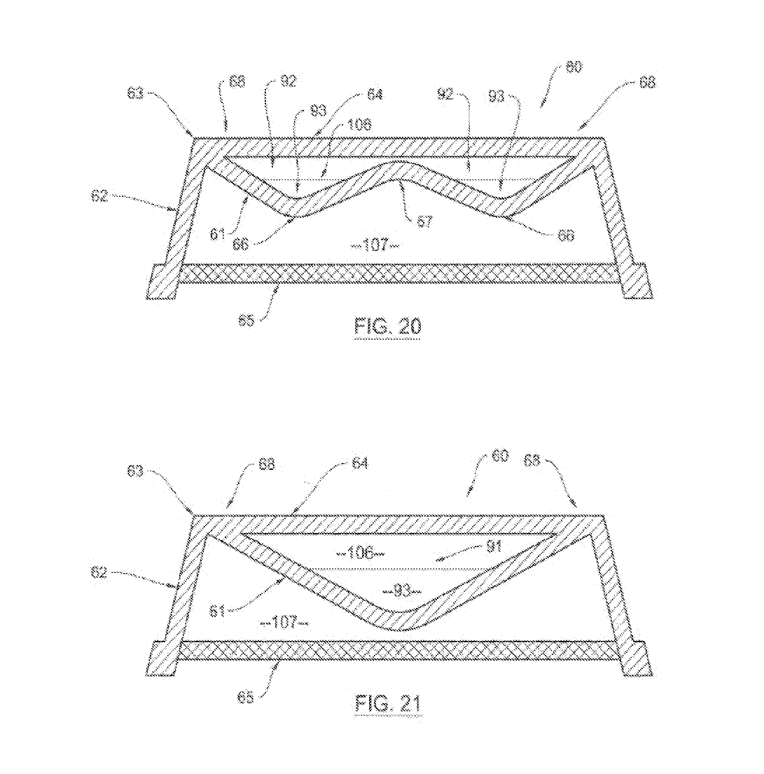

Referencing FIGS. 18 through 21, the reader is directed to first and second preferred embodiments according to the present invention, which preferred embodiments essentially provide a unibody lid-membrane combination or construction as at 50 in FIGS. 18 and 19, and as at 60 in FIGS. 20 and 21. The unibody lid-membrane combinations 50 and 60 essentially make the insert construction (as previously specified and referenced at 12) integrally formed with the lid construction or otherwise permanently attached to the lid construction as by being adhesively attached, ultrasonically welded thereto, or otherwise fused according to the alternative embodiments described hereinabove.

It is contemplated that the unibody (i.e. integrally formed or permanently attached) combination 50 provides a lower cost overall construction or combination usable in cooperative association with a beverage container as at 10 as opposed to manufacturing separate lid constructions and insert constructions to achieve the primary objectives of the present invention.

In the preferred embodiments 50 and 60, given the unibody (i.e. integrally formed or permanently attached) construction, the “insert or membrane construction” portion may be referred to as membrane portions 51 and 61. The membrane portions 51 and 61 are akin to the insert or membrane construction 12, but integrally formed with the side walls 52 or the upper corner junction 68 of the membrane-embracing lid portions 53 and 63 as the case may be. Side wall 62 of the lid portion 63 is referenced in FIGS. 20 and 21.

From a comparative inspection of FIGS. 18 through 21, it will be seen that the material construction is uniform and consistent throughout the lid portions 53/63 and the membrane portions 51/61, and preferably consists of a resilient polymeric material substantially as described hereinabove with reference to the insert construction 12. FIGS. 18 and 19 have been enlarged to depict the unibody (i.e. integrally formed or permanently attached) or uniform material consistency of the combination 50. The lid portions 53/63 of the combinations 50/60 preferably and respectively comprise lid tops 54/64 and lid bottoms or mouths or lower lid portions as at 55/65.

FIG. 18 depicts the membrane portion 51 of the unibody (i.e. integrally formed or permanently attached) lid-membrane combination 50 in a first, actuated or non-relaxed configuration, the membrane portion 51 being entirely concave relative to the lid bottom or lid mouth 55. By contrast, FIG. 19 depicts the membrane portion 51 of the unibody (i.e. integrally formed or permanently attached) lid-membrane combination 50 in a second, relaxed configuration, the membrane portion 51 being entirely convex relative to the lid bottom or lid mouth 55.

But for the unibody (i.e. integrally formed or permanently attached) construction of combination 50, almost all other aspects of the lid portion 53 and the membrane portion 51 function akin to the lid construction 11 (or 13) and the insert or membrane construction 12. See, for example, the primary lid outlet as referenced at 25 in FIGS. 18 and 19. In this regard, the reader should note, however, that the groove 31 (or the bead or flange 30) is/are removed from the lid portions 53 and 63. Since the membrane portions 51/61 are integrally formed to or with the lid portions 53/63, there is no structural requirement as exemplified by the groove 31 or bead 30 to structurally support or retain a separate element such as the insert construction 12.

FIG. 20 depicts the membrane portion 61 of the unibody (i.e. integrally formed or permanently attached) lid-membrane combination 60 in a first, actuated or non-relaxed configuration, the membrane portion 61 comprising an inverted convex ring or ridge as at 66 relative to the lid bottom or lid mouth 65 with an area of centralized concavity at the trough section 67 central to the convex ridge 66. In other words, the membrane 61 is dimpled at the area 67 intermediate the (circular) ridge 66. FIG. 21 is an enlarged cross-sectional depiction of the second preferred unibody (i.e. integrally formed or permanently attached) lid-membrane combination 60 showing the membrane portion 61 of the unibody (i.e. integrally formed or permanently attached) lid-membrane combination 60 in a second relaxed configuration, the entire membrane portion being convex relative to the lid bottom or lid mouth 65.

The lid-membrane combinations according to the present invention thus provide a unibody-membraned container lid construction or lid-membrane combinations as at 50/60 for enabling a user to transfer heat from a relatively hot assembly-contained beverage. The lid-membrane combinations 50/60 thus preferably comprise lid portion as at 53/63, and a membrane portion as at 51/61 integrally formed with the lid portions 53/63. The lid portions comprise lid walls as at 52/62, and a primary beverage outlet as at 25.

The membrane portions 51/61 extend intermediate the lid walls 52 or are lid-traversing for defining a lower beverage-receiving compartment and an upper beverage-cooling compartment 106. The lid and membrane portions are constructed from a uniform resilient material, and the membrane portion may be said to define a primary dam structure. The primary dam structure functions to transfer beverage intermediate the beverage-containing and beverage-cooling compartments when the combinations 50/60 are outfitted upon a beverage containing container.

The beverage-cooling compartment 106 receives heat from the beverage before said beverage exits the primary beverage outlet 25. The primary dam structure preferably comprises a series of apertures (as at 28 not specifically illustrated in FIGS. 18 through 21), which apertures extend inwardly from the lid walls 52/62 for enabling the user to control beverage flow rates via the series of apertures by angling a lidded beverage container relative to the beverage surface. The resilient material of the membrane (and lid) portions 51/61 is biasable intermediate a relaxed beverage cooling configuration as in FIGS. 19 and 21, and an actuated packaging configuration as in FIG. 18 and FIG. 20. The relaxed beverage cooling configuration may be configured by dynamically altering the forces attendant to the actuated packaging configuration.

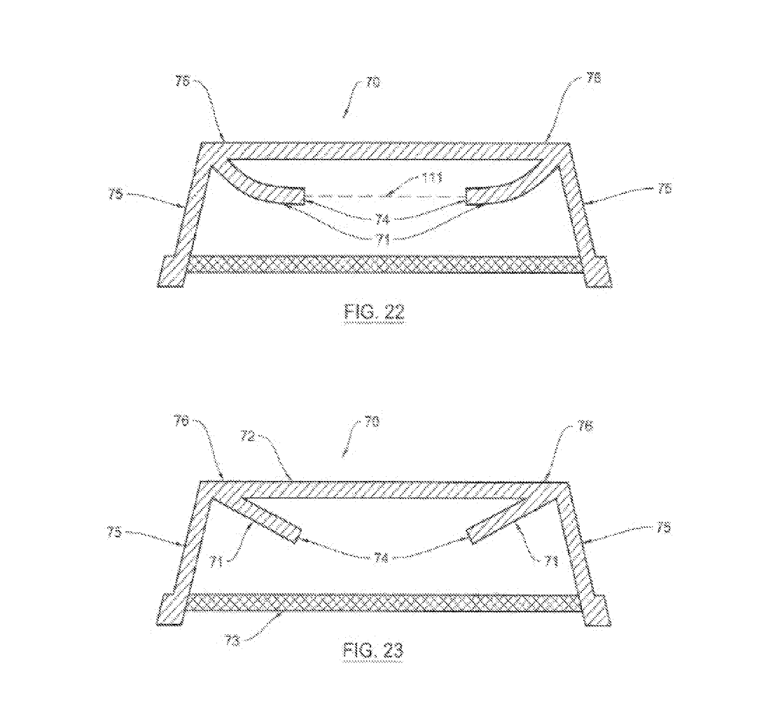

FIGS. 22 and 23 depict first and second views of an alternative unibody (i.e. integrally formed or permanently attached) lid-spring combination 70 according to the present invention. The unibody lid-spring combination 70 essentially eliminates the lid-traversing aspect of the membrane extending intermediate the lid wall, and instead provides a resilient annular ring 71 that extends downwardly toward the lid bottom 73 oblique relative to the lid top 72 from the lid wall 75 and/or top-to-wall junction 76 when in the relaxed configuration generally depicted in FIG. 23. When actuated, the annular ring 71 is biased upwardly toward the lid top 72 such that the radially inner spring terminus 74 is coplanar with the lid top 72, extending in a plane 111.

It will be understood that the unibody lid-spring combination 70 addressed the primary objective of providing a spring-lid combination that essentially operates to reduce packaging space by providing or enabling the compressed stacked lid assembly formation generally demonstrated in FIG. 17. In other words, the stacked lid-spring combinations 70, when compressed, form actuated stacked formations akin to compressibly stacked formations 44, which require force maintenance means to maintain the stacked formations 44 in a compressed state. When the force maintenance means are removed, the individually stacked lid-spring formations 70 become decompressed thereby resembling the decompressed stacked formation 46.

Referencing FIGS. 24-41, the reader there see certain preferred alternative embodiments according to the present invention, which figures are presented to basically show or support certain beverage-letting and/or certain beverage-pooling mechanisms according to the principles of the present invention. FIG. 24, for example, is a transverse cross-sectional, diagrammatic type depiction as sectioned from FIG. 25 of the second preferred unibody (i.e. integrally formed or permanently attached) lid-membrane combination 50 according to the present invention.

The lid-membrane combination 50 shown in FIGS. 24 and 25 comparatively shows the membrane portion 51 of the unibody lid-membrane combination 50 while in a downwardly arched, relaxed configuration with pooled or compartmentalized beverage 93 being pooled centrally circular as at 91 within a beverage-pooling zone 90. Certain beverage-letting apertures as at 28 preferably extend in lateral or peripheral adjacency to the primary beverage outlet as at 25.

The apertures 28 are preferably located in lateral or peripheral adjacency to the primary beverage outlet 25 to prevent direct entry of hot beverage 101 from the compartment 106 into the user's mouth via the outlet 25. Rather, hot beverage 101 is slowed by the offset structural configuration of the apertures 28 relative to the outlet 25 thereby enabling added heat to transfer from the beverage flow 103 prior to consumption.

FIG. 25 is an enlarged, longitudinal cross-sectional depiction of the second preferred unibody (i.e. integrally formed or permanently attached) lid-membrane combination 50 shown attached to a fragmentary container 10 containing beverage 101 showing the membrane portion 51 of the unibody lid-membrane combination 50 in a relaxed configuration with pooled beverage 93 being pooled centrally within a beverage-pooling zone 90.

FIG. 26 is a diagrammatic cross-sectional first sequential side view depiction of the second preferred unibody (i.e. integrally formed or permanently attached) lid-membrane combination 50 according to the present invention attached to a fragmentary container construction 10 containing beverage 101 and showing the membrane portion 51 of the unibody lid-membrane combination 50 in a downwardly arched, relaxed configuration to show relative positions of the lid-insert combination 50 and container construction 10 after assembly in an upright position, the contained beverage 101 having a horizontal beverage surface parallel to the a lid top 54 of the lid construction.

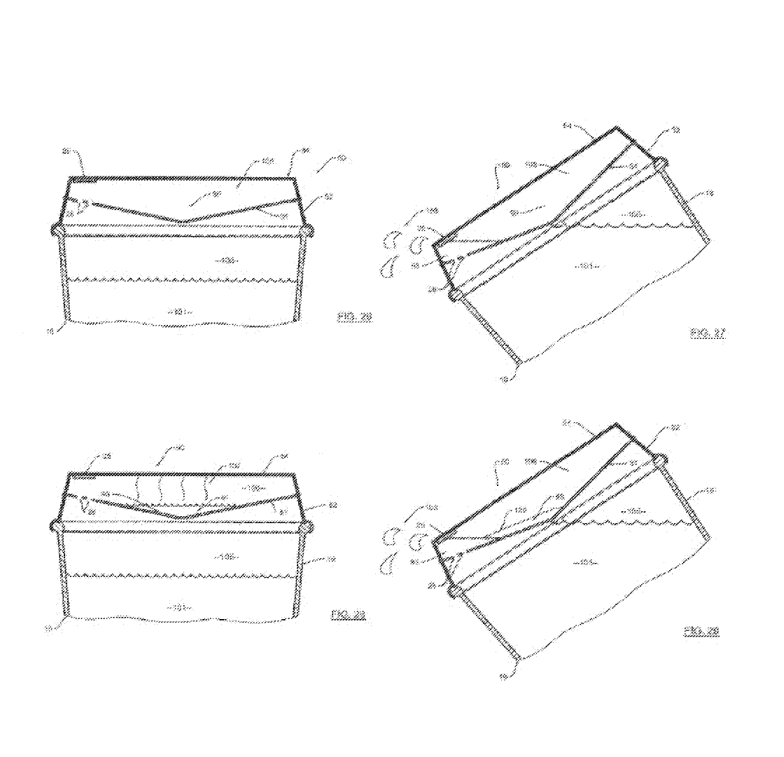

FIG. 27 is a diagrammatic cross-sectional second sequential side view depiction of the second preferred unibody (i.e. integrally formed or permanently attached) lid-membrane combination 50 according to the present invention attached to a fragmentary container construction 10 containing beverage 101 and showing the membrane portion 51 of the unibody lid-membrane combination 50 in a relaxed configuration to show relative positions of the lid-insert combination 50 and container construction 10 after assembly in a first angled position. The contained beverage 101 thereby has a horizontal beverage surface angled at the first angled position relative to the lid top 54 of the lid construction to allow contained beverage 101 to permeate apertures 28 formed in the resilient insert or membrane construction 51.

FIG. 28 is a diagrammatic cross-sectional third sequential side view depiction of the second preferred unibody (i.e. integrally formed or permanently attached) lid-membrane combination 50 according to the present invention attached to a fragmentary container construction 10 containing beverage 101 and showing the membrane portion 51 of the unibody lid-membrane combination 50 in a relaxed configuration to show relative positions of the lid-insert combination 50 and container construction 10 after assembly again in an upright position. The contained beverage 101 has a horizontal beverage surface parallel to the lid top 54 of the lid construction to allow aperture-permeated, compartmentalized beverage 93 to pool upon the concave surface of the insert or membrane construction 51 relative to the lid top 54 at a beverage-pooling zone 90, which zone 90 is centrally circular as at 91.

FIG. 29 is a diagrammatic cross-sectional fourth sequential side view depiction of the second preferred unibody (i.e. integrally formed or permanently attached) lid-membrane combination 50 according to the present invention attached to a fragmentary container construction 10 containing beverage 101 and showing the membrane portion 51 of the unibody lid-membrane combination 50 in a relaxed configuration to show relative positions of the lid-insert combination 50 and container construction 10 after assembly in a second angled position. The contained beverage 101 has a horizontal beverage surface angled relative to the lid top 54 of the lid construction in the second angled position to allow aperture-permeated beverage 93 to outlet as at flow 103 through a primary beverage outlet 25 aperture formed in the lid construction.

Summarizing FIGS. 26-29, FIG. 26 represents the overall assembly not yet engaged. FIG. 27 represents the first sip, beverage 101 going through the apertures 28 in the damming structure 26 slightly delaying and preventing hot beverage 101 from directly entering the outlet 25. FIG. 28 represents the back to horizontal position whereby compartmentalized beverage 93 pools or collects at the pooling zone 90 provided by the relaxed or downwardly arched membrane 51 for added heat 100 transfer therefrom. FIG. 29 represents the next sip, whereby cooled beverage from the beverage-pooling zone 90 rushes down as at 120 to the main outlet 25, and simultaneously, hot beverage 101 from the compartment 105 enters through the apertures 28 of the damming structure 26, mixing with the compartmentalized (cooled) beverage 93 and progresses to the main outlet 25.

FIG. 30 is a transverse cross-sectional, diagrammatic type depiction as sectioned from FIG. 31 of a third preferred unibody (i.e. integrally formed or permanently attached) lid-membrane combination 80 according to the present invention showing the membrane portion 81 of the unibody lid-membrane combination 80 in an upwardly arched configuration with pooled beverage 93 being pooled radially peripherally within an annular beverage-pooling zone 92 according to the present invention.

Beverage-letting apertures 28 preferably extend radially in lateral or peripheral adjacency to the primary beverage outlet 25 for creating a diverted beverage flow path and slowing the delivery thereof via outlet 25 for enhancing heat 100 transfer from the flow 103. An air-letting aperture 82 is further provided in the upwardly arched membrane portion 81, which membrane portion 81 is preferably attached at a (centralized) roof point or site 83 of the lid top 84. Notably, heat 100 transfer may also occur via the lid wall 85 in this annular pool zone 92 arrangement as generally depicted and referenced in FIG. 31.

FIG. 31 is an enlarged, longitudinal cross-sectional depiction of the third preferred unibody (i.e. integrally formed or permanently attached) lid-membrane combination 80 according to the present invention attached to a fragmentary container construction 10 containing beverage 101 showing the membrane portion 81 of the unibody lid-membrane combination 80 in an upwardly arched configuration with pooled beverage 93 being pooled radially peripherally and annularly within an annular beverage-pooling zone 92 according to the present invention.

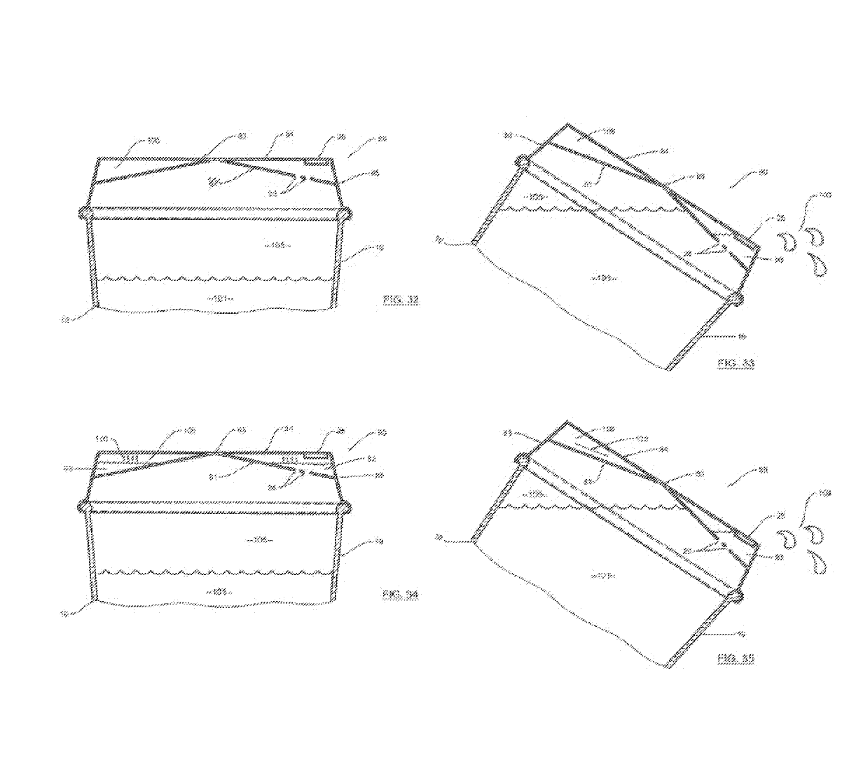

FIG. 32 is a diagrammatic cross-sectional first sequential side view depiction of the third preferred unibody (i.e. integrally formed or permanently attached) lid-membrane combination 80 according to the present invention attached to a fragmentary container construction 10 containing beverage 101 and showing the membrane portion 81 of the unibody lid-membrane combination 80 in an upwardly arched configuration to show relative positions of the lid-insert combination 80 and container construction 10 after assembly in an upright position. The contained beverage 101 has a horizontal beverage surface parallel to the lid top 84 of the lid construction.

FIG. 33 is a diagrammatic cross-sectional second sequential side view depiction of the third preferred unibody (i.e. integrally formed or permanently attached) lid-membrane combination 80 according to the present invention attached to a fragmentary container construction 10 containing beverage 101 and showing the membrane portion 81 of the unibody lid-membrane combination 80 in an upwardly arched configuration to show relative positions of the lid-insert combination 80 and container construction 10 after assembly in a first angled position. The contained beverage 101 in this view has a horizontal beverage surface angled at the first angled position relative to the lid top 84 of the lid construction to allow contained beverage 101 to permeate apertures 28 formed in the resilient insert or membrane construction 81.

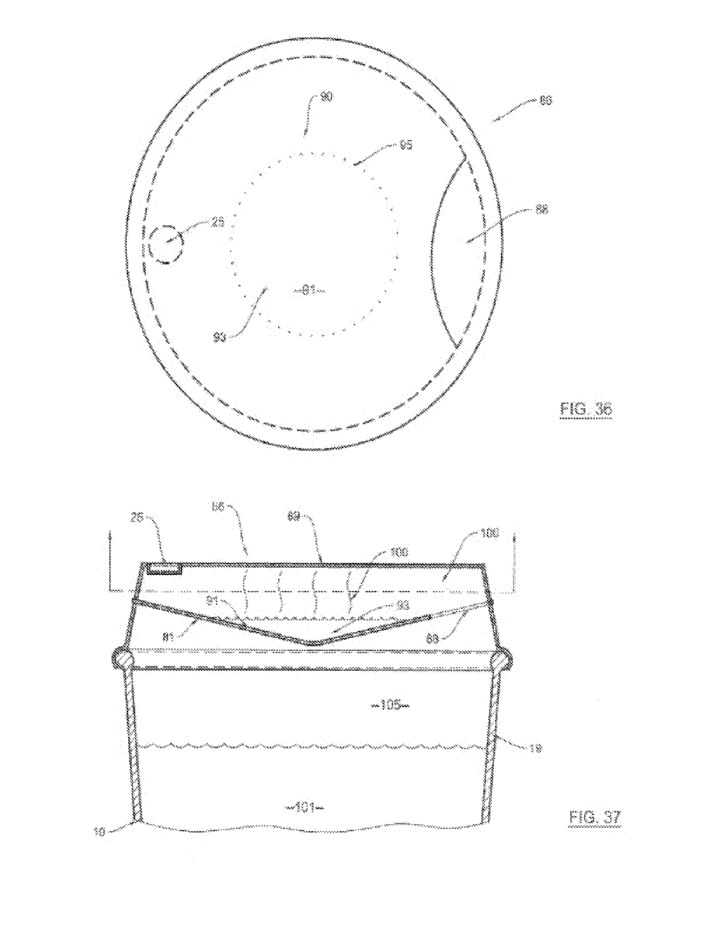

FIG. 34 is a diagrammatic cross-sectional third sequential side view depiction of the third preferred unibody (i.e. integrally formed or permanently attached) lid-membrane combination 80 according to the present invention attached to a fragmentary container construction 10 containing beverage 101 and showing the membrane portion 81 of the unibody lid-membrane combination 80 in an upwardly arched configuration to show relative positions of the lid-insert combination 80 and container construction 10 after assembly again in an upright position. The contained beverage 101 has a horizontal beverage surface parallel to the lid top 84 of the lid construction to allow aperture-permeated beverage 93 to pool upon the upwardly arched surface of the insert or membrane construction 81 relative to the lid top 84 at an annular beverage-pooling zone 92. FIG. 35 is a diagrammatic cross-sectional fourth sequential side view depiction of the third preferred unibody (i.e. integrally formed or permanently attached) lid-membrane combination 80 according to the present invention attached to a fragmentary container construction 10 containing beverage 101 and showing the membrane portion 81 of the unibody lid-membrane combination 80 in an upwardly arched configuration to show relative positions of the lid-insert combination 80 and container construction 10 after assembly in a second angled position. The contained beverage 101 has a horizontal beverage surface angled relative to the lid top 84 of the lid construction in the second angled position to allow aperture-permeated beverage 93 to outlet through a primary beverage outlet aperture 25 formed in the lid construction.

Summarizing FIGS. 32-35, FIG. 32 represents the overall assembly not yet engaged. FIG. 33 represents the first sip, beverage 101 going through the apertures 28 in the damming structure 26 of the membrane 81 slightly delaying and preventing hot beverage 101 from directly entering the outlet 25. FIG. 34 represents the back to horizontal position whereby compartmentalized beverage 93 pools or collects at the annular pooling zone 92 provided by the upwardly downwardly arched membrane 81 for added heat 100 transfer therefrom, including heat 100 transfer via the lid wall 85. FIG. 35 represents the next sip, whereby cooled beverage from the annular beverage-pooling zone 92 rushes down as at 120 to the main outlet 25, and simultaneously, hot beverage 101 from the compartment 105 enters through the apertures 28 of the damming structure 26 of the membrane 81, mixing with the compartmentalized (cooled) beverage 93 and progresses to the main outlet 25.

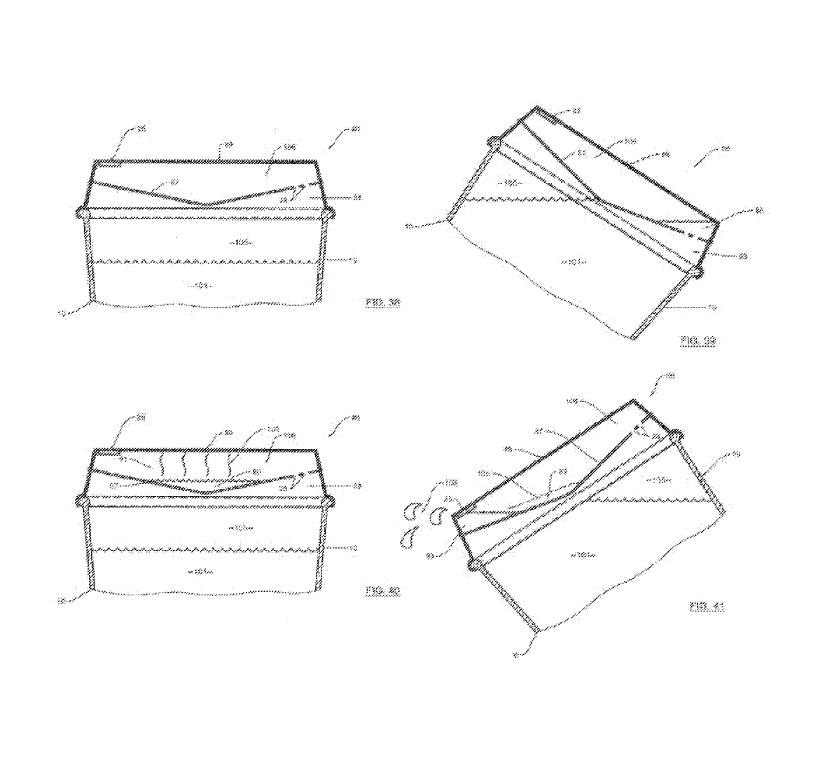

FIG. 36 is a transverse cross-sectional, diagrammatic type depiction as sectioned from FIG. 37 of a fourth preferred unibody (i.e. integrally formed or permanently attached) lid-membrane combination 86 according to the present invention showing the membrane portion 87 of the unibody lid-membrane combination 86 in a downwardly arched, relaxed configuration with pooled beverage 93 being pooled centrally circular as at 91 within a beverage-pooling zone 90 according to the present invention and a single beverage-letting aperture 88 being formed therein circumferentially opposite the primary beverage outlet 25. The beverage-letting aperture 88 is relatively large and located in opposite direction from the main aperture or outlet 25.

FIG. 37 is an enlarged, longitudinal cross-sectional depiction of the fourth preferred unibody (i.e. integrally formed or permanently attached) lid-membrane combination 86 according to the present invention attached to a fragmentary container construction 10 containing beverage 101 showing the membrane portion 87 of the unibody lid-membrane combination 86 in an downwardly arched, relaxed configuration with pooled beverage 93 being pooled centrally within a beverage-pooling zone 90 according to the present invention. The aperture 88 in the membrane 87 is shown at the right of the figure. The aperture 88, being of a relatively large stature or formation is designed for letting thicker or more viscous beverages such as soup and the like.

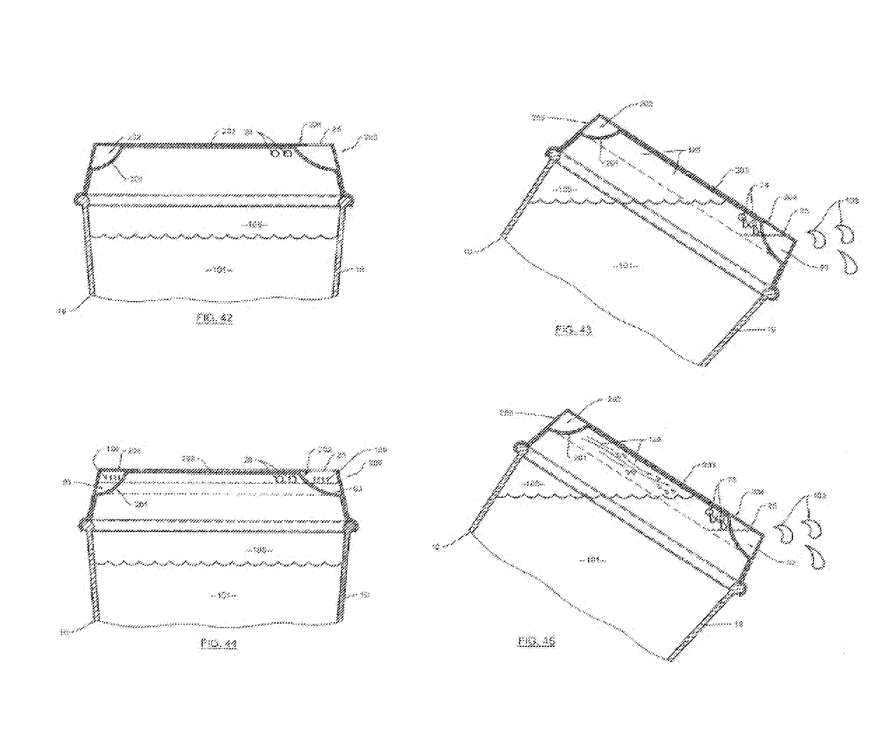

FIG. 38 is a diagrammatic cross-sectional first sequential side view depiction of the fourth preferred unibody (i.e. integrally formed or permanently attached) lid-membrane combination 86 according to the present invention attached to a fragmentary container construction 10 containing beverage 101 and showing the membrane portion 87 of the unibody lid-membrane combination 86 in a downwardly arched, relaxed configuration to show relative positions of the lid-insert combination 86 and container construction 10 after assembly in an upright position. The contained beverage 101 has a horizontal beverage surface parallel to the lid top 89 of the lid construction.

FIG. 39 is a diagrammatic cross-sectional second sequential side view depiction of the fourth preferred unibody (i.e. integrally formed or permanently attached) lid-membrane combination 86 according to the present invention attached to a fragmentary container construction 10 containing beverage 101 and showing the membrane portion 87 of the unibody lid-membrane combination in a downwardly arched, relaxed configuration to show relative positions of the lid-insert combination 86 and container construction 10 after assembly in a first angled position. The contained beverage 101 has a horizontal beverage surface angled at the first angled position relative to the lid top 89 of the lid construction to allow contained beverage 101 to permeate the preferred aperture 88 formed in the resilient insert or membrane construction 87.

FIG. 40 is a diagrammatic cross-sectional third sequential side view depiction of the fourth preferred unibody (i.e. integrally formed or permanently attached) lid-membrane combination 86 according to the present invention attached to a fragmentary container construction 10 containing beverage 101 and showing the membrane portion 87 of the unibody lid-membrane combination 86 in a downwardly arched, relaxed configuration to show relative positions of the lid-insert combination 86 and container construction 19 after assembly again in an upright position. The contained beverage 101 has a horizontal beverage surface parallel to the lid top 89 of the lid construction to allow aperture-permeated beverage 93 (permeating alternative or optional apertures 28) to pool upon the downwardly arched surface of the insert or membrane construction 87 relative to the lid top at a central beverage-pooling zone 91.

FIG. 41 is a diagrammatic cross-sectional fourth sequential side view depiction of the fourth preferred unibody (i.e. integrally formed or permanently attached) lid-membrane combination 86 according to the present invention attached to a fragmentary container construction 10 containing beverage 101 and showing the membrane portion 87 of the unibody lid-membrane combination 86 in a downwardly arched, relaxed configuration to show relative positions of the lid-insert combination 86 and container construction 10 after assembly in a second angled position. The contained beverage 101 has a horizontal beverage surface angled relative to the lid top 89 of the lid construction in the second angled position to allow aperture-permeated beverage 93 to outlet through a primary beverage outlet aperture 25 formed in the lid construction.

Summarizing FIGS. 38-41, FIG. 38 represents the overall assembly not yet engaged. FIG. 39 represents a first tilt in a direction away from the primary beverage outlet 25. Beverage 101 permeates aperture 88 in the damming structure 26 of the membrane 87 slightly delaying and preventing hot beverage 101 from directly entering the outlet 25. FIG. 40 represents the back to horizontal position whereby compartmentalized beverage 93 pools or collects at a centralized pooling zone 91 provided by the downwardly downwardly arched membrane 87 for added heat 100 transfer therefrom. FIG. 41 represents the next sip, whereby cooled beverage from the central beverage-pooling zone 91 rushes down as at 120 to the main outlet 25. Notably, hot beverage 101 from the compartment 105 does not enters through the apertures 28 or aperture 88 of the damming structure 26 of the membrane 87, and thus does not mix with the compartmentalized (cooled) beverage 93.

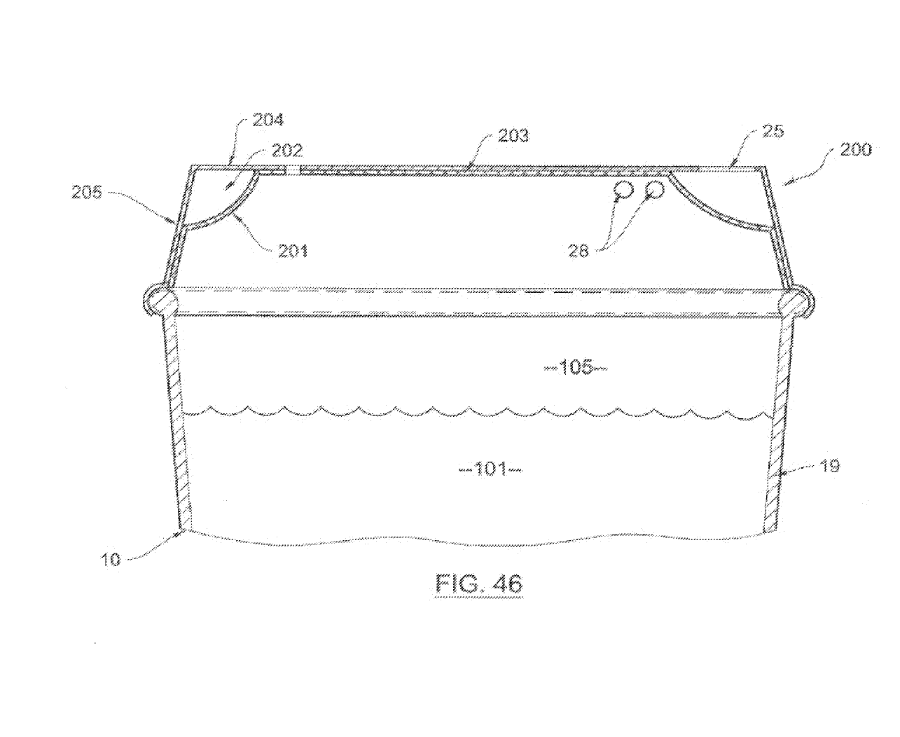

FIGS. 42 and 46 are diagrammatic cross-sectional first sequential side view depictions of a fifth preferred lid-membrane combination 200 according to the present invention attached to a fragmentary container construction 10 containing beverage 101 and showing the membrane portion 201 of the lid-membrane combination 200 defining a peripheral, annular beverage-pooling compartment 202 to show relative positions of the lid-insert combination 200 and container construction 10 after assembly in an upright position, the contained beverage 101 having a horizontal beverage surface parallel to the a lid top 203 of the lid construction 204.

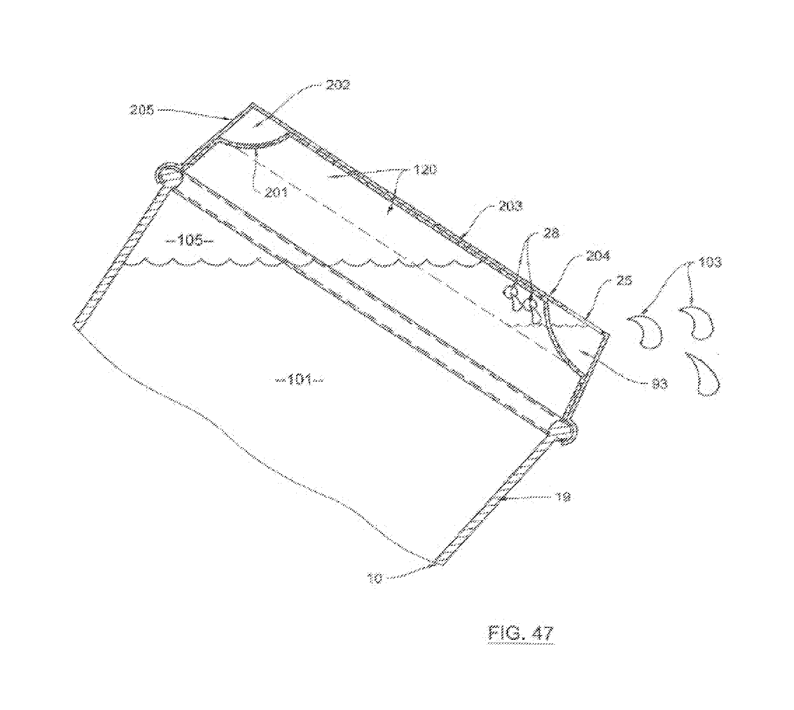

FIGS. 43 and 47 are diagrammatic cross-sectional second sequential side view depictions of the fifth preferred lid-membrane combination 200 according to the present invention attached to a fragmentary container construction 10 containing beverage 101 and showing the membrane portion 201 of the lid-membrane combination 200 defining a peripheral, annular beverage-pooling compartment 202 to show relative positions of the lid-insert combination 200 and container construction 10 after assembly in a first angled position. The contained beverage 101 has a horizontal beverage surface angled at the first angled position relative to the lid top 203 of the lid construction 204 to allow contained beverage 101 to permeate the apertures 28 formed in the insert or membrane construction 201.

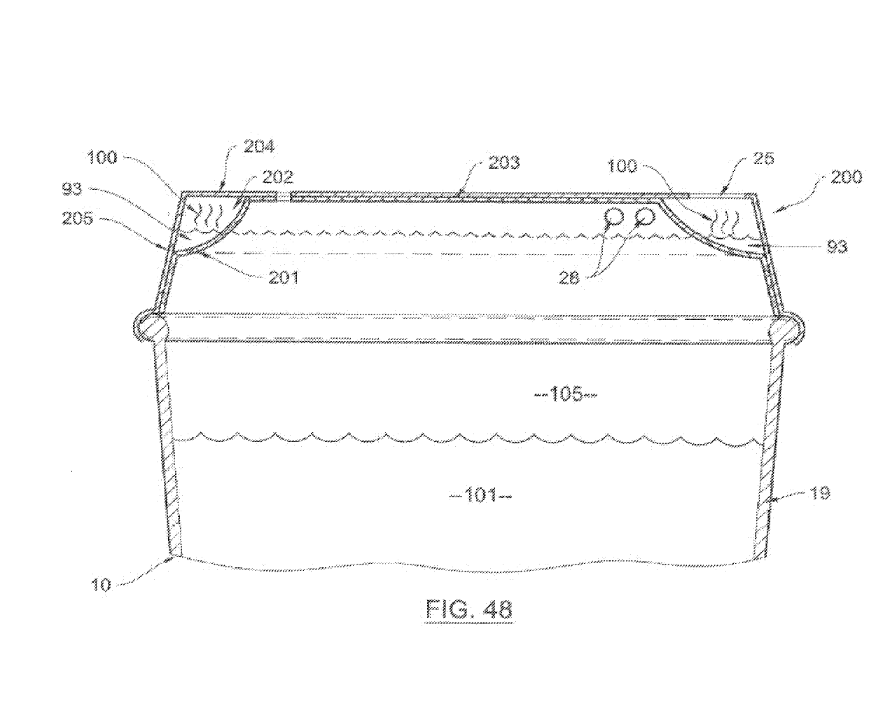

FIGS. 44 and 48 are diagrammatic cross-sectional third sequential side view depictions of the fifth preferred lid-membrane combination 200 according to the present invention attached to a fragmentary container construction 10 containing beverage 101 and showing the membrane portion 201 of the lid-membrane combination 200 defining a peripheral, annular beverage-pooling compartment 202 to show relative positions of the lid-insert combination 200 and container construction 10 after assembly again in an upright position. The contained beverage 101 has a horizontal beverage surface parallel to the lid top 203 of the lid construction 204 to allow aperture-permeated beverage 93 to pool within the peripheral, annular beverage-pooling compartment 202 defined by the insert or membrane construction 201.

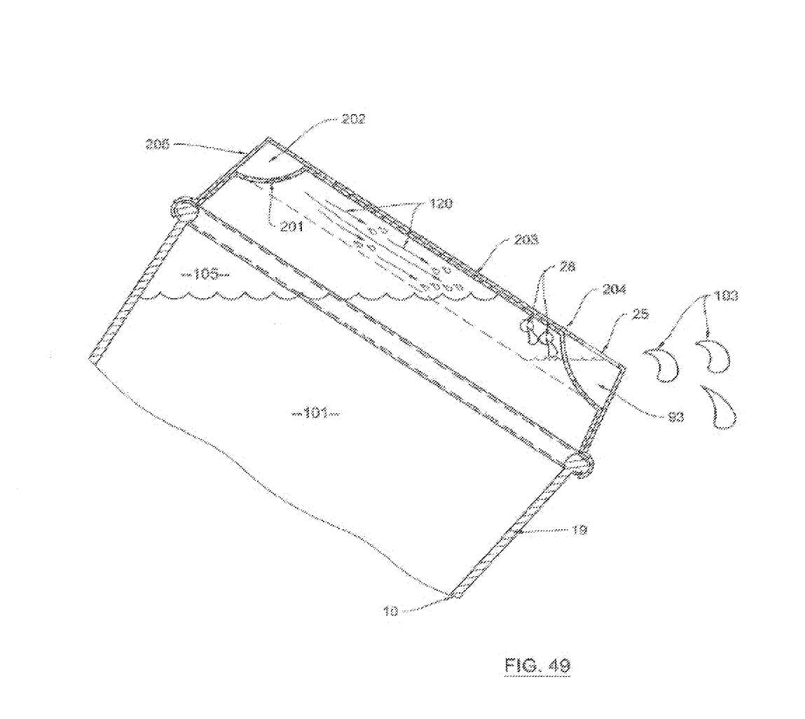

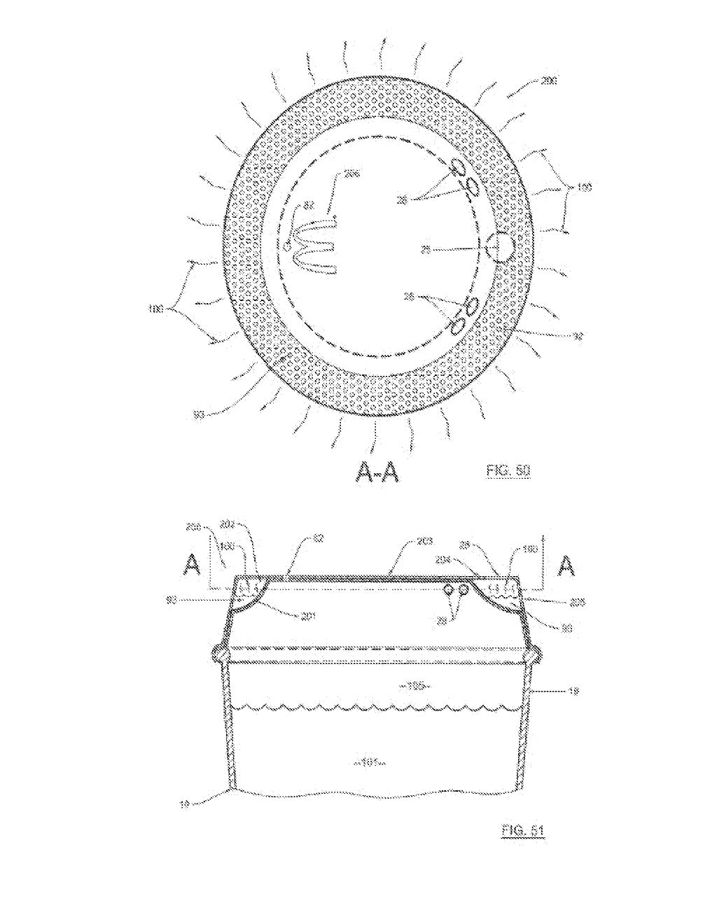

FIGS. 45 and 49 are diagrammatic cross-sectional fourth sequential side view depictions of the fifth preferred lid-membrane combination 200 according to the present invention attached to a fragmentary container construction 10 containing beverage 101 and showing the membrane portion 201 of the lid-membrane combination 200 defining a peripheral, annular beverage-pooling compartment 202 to show relative positions of the lid-insert combination 200 and container construction 10 after assembly in a second angled position. The contained beverage 101 has a horizontal beverage surface angled relative to the lid top 203 of the lid construction 204 in the second angled position to allow aperture-permeated beverage 93 to outlet through a primary beverage outlet aperture 25 formed in the lid construction 204.

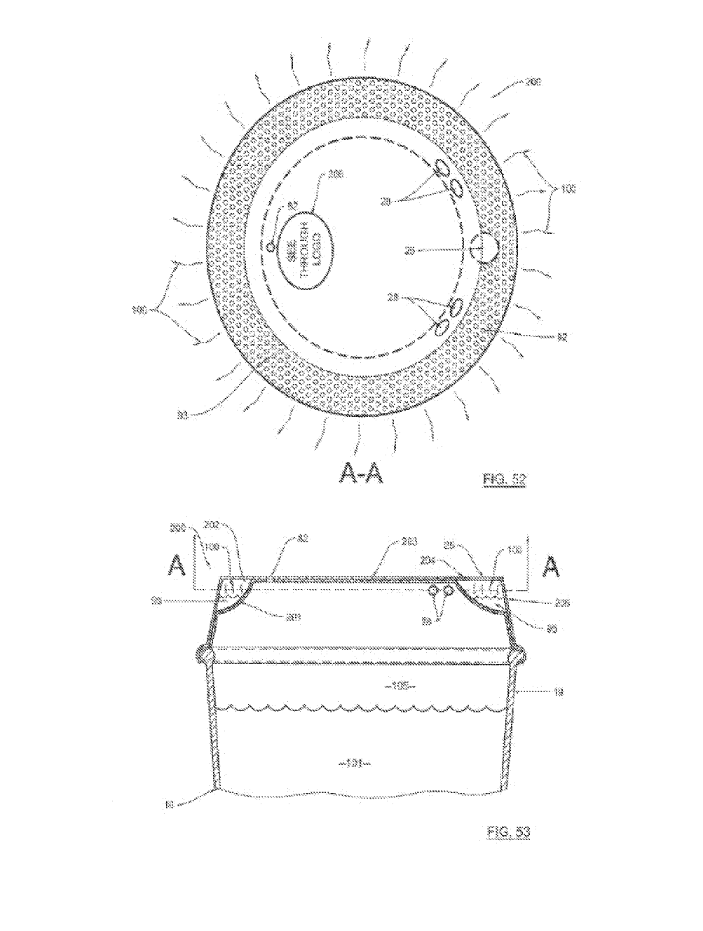

FIG. 50 is a transverse cross-sectional, diagrammatic type depiction as sectioned from FIG. 51 of the fifth preferred lid-membrane combination 200 according to the present invention showing the membrane portion 201 of the lid-membrane combination 200 defining a peripheral, annular beverage-pooling compartment 202 showing pooled beverage 93 being pooled peripherally or annularly within an annular beverage-pooling zone 92 according to the present invention with radially directed heat 100 transfer via the lid wall 205 of the lid construction 204.

The lid top 203 may be preferably outfitted with certain markings to depict branding as at 206. In this regard the lid top 203 may preferably further comprise a top window 207 and have a first coloration (such as black coloration) and the membrane portion 201 may be provided with markings and or second coloration (such as yellow coloration) to depict branding, trade dress or logo information viewable through the window 207 when the membrane portion 201 is outfitted with the lid construction 204 as generally and comparatively depicted in FIGS. 50 and 52. The first and second coloration may thus present contrasting coloration to enhance the visual appeal of the combination 200.

FIGS. 51 and 53 are enlarged, longitudinal cross-sectional depictions of the fifth preferred lid-membrane combination 200 according to the present invention attached to a fragmentary container construction 10 containing beverage 101 and showing the membrane portion 201 of the lid-membrane combination 200 defining a peripheral, annular beverage-pooling compartment 202 with compartment-pooled beverage 93 being pooled peripherally or annularly within an annular beverage-pooling zone 92 according to the present invention.

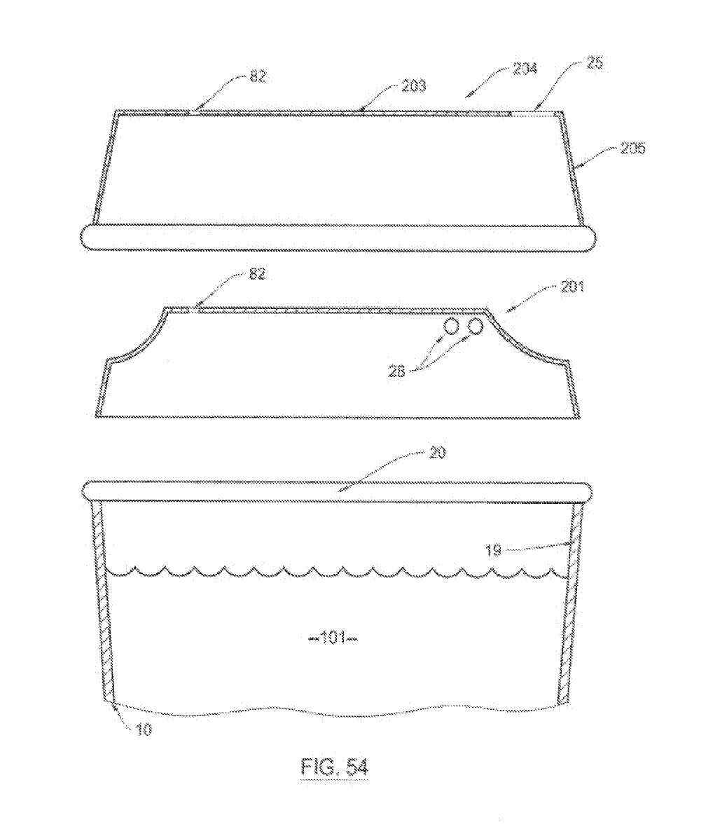

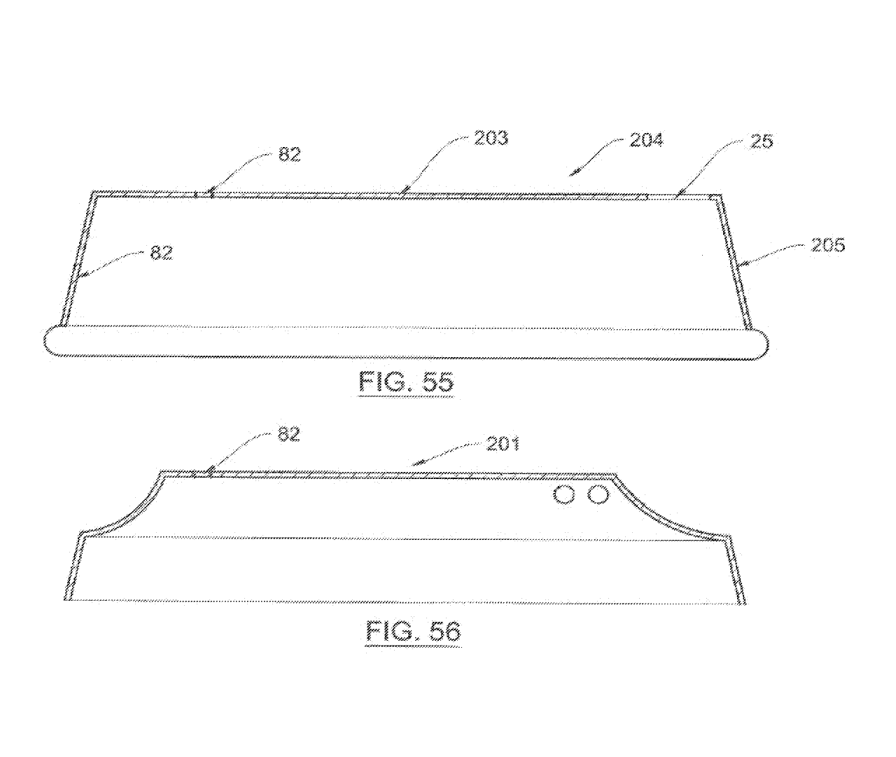

FIG. 54 is an enlarged, exploded longitudinal cross-sectional depiction of the fifth preferred lid-membrane combination 200 according to the present invention depicting from bottom to top (1) a fragmentary container construction 10 containing beverage 101, (2) the membrane portion 201 of the lid-membrane combination 200, and (3) a lid construction 204 according to the present invention. FIG. 55 is an enlarged, exploded longitudinal cross-sectional depiction of the lid construction 204 of the fifth preferred lid-membrane combination 200 according to the present invention. FIG. 56 is an enlarged, exploded longitudinal cross-sectional depiction of the membrane construction 201 of the fifth preferred lid-membrane combination 200 according to the present invention.

While the foregoing specifications set forth much specificity, the same should not be construed as setting forth limits to the invention but rather as setting forth certain preferred embodiments and features. For example, as prefaced hereinabove, it is contemplated that the present invention essentially provides an insert construction for outfitting a lidded beverage container so as to enable a user to transfer heat from a relatively hot assembly-contained beverage.

The insert construction may be sized and shaped for attachment at or integrally formed with a container lid perimeter for defining a lower beverage-receiving compartment and an upper beverage-cooling compartment. The insert construction may be preferably constructed from a resilient material and may comprise or provide a primary dam structure. The primary dam structure transfers beverage intermediate the lower beverage-containing and the upper beverage-cooling compartments. The beverage-cooling compartment receives heat from the beverage before said beverage exits a primary beverage outlet.

The primary dam structure or beverage-damming portion may comprises at least one, and preferably a series of apertures, which series of apertures preferably extend inwardly and/or peripherally relative to container lid perimeter for enabling the user to control beverage flow rates via the series of apertures by variously angling the lidded beverage container. The resilient material may be preferably biasable intermediate a beverage cooling configuration and a packaging configuration, the beverage cooling configuration being optionally configured by dynamically altering the forces attendant to the packaging configuration.

In addition to the foregoing structural considerations, it is further believed that the inventive concepts discussed support certain new packaging methodologies and/or processes associated with the container lid construction described and exemplified hereinabove. In this regard, it is contemplated that the foregoing structural considerations support a packing method for minimizing packaging space and providing end-users with pre-relaxed lid-insert combinations. The packaging method is believed to essentially comprise the initial step of outfitting a series of lid constructions with a series of relaxed resilient insert constructions thereby forming a series of insert-outfitted or membrane-outfitted lid assemblies, each resilient insert or membrane construction being reconfigurable intermediate the relaxed configuration and an actuated configuration.

The series of insert-outfitted or membrane-outfitted lid assemblies are then stacked in a relaxed stacked columnar formation whereafter the relaxed stacked columnar formation is compressed into a compressed stacked columnar formation by configuring the resilient insert or membrane constructions into the actuated configurations. The compressed stacked columnar formation are maintained in the compressed formation via certain force maintenance means, and shipped to an end user. The force-maintenance means may be removed once received by the end user, which action operates to automatically decompress the compressed stacked columnar formation to a decompressed stacked columnar formation by reconfiguring the resilient insert or membrane constructions from the actuated configuration to the relaxed configurations.

Accordingly, although the invention has been described by reference to certain preferred and alternative embodiments and certain methodologies associated therewith, it is not intended that the novel arrangements and methods be limited thereby, but that modifications thereof are intended to be included as falling within the broad scope and spirit of the foregoing disclosures, the appended drawings, and the following claims.

I claim:

1. A container lid construction, the container lid construction comprising: an upper lid construction, a membrane portion and a primary beverage outlet formed in the upper lid construction, the membrane portion extending in inferior adjacency to the primary beverage outlet for defining a lower beverage compartment and an upper beverage compartment when container lid construction is outfitted upon a beverage container, the membrane portion being constructed from a resilient material, the resilient material being biasable intermediate a relaxed configuration and an actuated configuration.

2. The container lid construction of claim 1 wherein the membrane portion provides a primary dam structure, the primary dam structure for selectively transferring beverage intermediate the lower and upper beverage compartments, the upper beverage compartment for receiving heat from the beverage before said beverage exits the primary beverage outlet.

3. The container lid construction of claim 2 wherein the primary dam structure comprises at least one aperture, the at least one aperture for enabling the user to selectively control beverage flow rates by angling the beverage container outfitted with the container lid construction relative to a beverage surface.

4. The container lid construction of claim 1 wherein the membrane portion is downwardly-bowed portion when in the relaxed configuration, the downwardly-bowed portion defining a beverage-pooling zone, the beverage-pooling zone for enhancing heat transfer from the beverage before exiting the primary beverage outlet.

5. The container lid construction of claim of claim 1 wherein the membrane portion provides a beverage-pooling zone, the beverage-pooling zone being annularly-shaped, the annularly-shaped beverage-pooling zone for enhancing heat transfer from the beverage before exiting the primary beverage outlet.

6. The container lid construction of claim of claim 5 wherein the annularly-shaped beverage pooling zone enables radially directed heat transfer via a lid wall of the upper lid construction.

7. The container lid construction of claim 3 wherein the primary dam structure comprises a series of apertures, the series of apertures for enhancing a user's ability to selectively control beverage flow rates.

8. The container lid construction of claim 1 wherein the membrane portion is removably attached to container lid construction.

9. The container lid construction of claim 1 comprising a unibody construction.

10. A container lid construction, the container lid construction comprising: an upper lid construction, a membrane portion, and a primary beverage outlet formed in the upper lid construction, the membrane portion extending in inferior adjacency to the primary beverage outlet for defining a lower beverage compartment and an upper beverage compartment when the lid construction is outfitted upon a beverage container, the membrane portion being configurable in a non-planar configuration for forming a beverage-pooling zone within the upper beverage compartment.

11. The container lid construction of claim 10 wherein the membrane portion is constructed from a resilient material, the resilient material being biasable intermediate a relaxed configuration and an actuated configuration.

12. The container lid construction of claim 10 wherein the membrane portion provides a primary dam structure, the primary dam structure for selectively transferring beverage intermediate the lower and upper beverage compartments, the upper beverage compartment for receiving heat from the beverage before said beverage exits the primary beverage outlet.

13. The container lid construction of claim 12 wherein the primary dam structure comprises at least one aperture, the at least one aperture for enabling the user to selectively control beverage flow rates by angling the beverage container outfitted with the container lid construction relative to a beverage surface.

14. The container lid construction of claim 11 wherein the membrane portion is downwardly-bowed portion when in the relaxed configuration, the downwardly-bowed portion defining the beverage-pooling zone, the beverage-pooling zone for enhancing heat transfer from the beverage before exiting the primary beverage outlet.

15. The container lid construction of claim 10 wherein the beverage-pooling zone is annularly-shaped, the annularly-shaped beverage-pooling zone for enhancing heat transfer from the beverage before exiting the primary beverage outlet.

16. The container lid construction of claim 15 wherein the annularly-shaped beverage pooling zone enables radially directed heat transfer via a lid wall of the upper lid construction.

17. The container lid construction of claim 13 wherein the primary dam structure comprises a series of apertures, the series of apertures for enhancing a user's ability to selectively control beverage flow rates.

18. The container lid construction of claim 10 wherein the membrane portion is removably attached to container lid construction.

19. The container lid construction of claim 10 comprising a unibody construction.

20. The container lid construction of claim of claim 10 wherein the membrane portion is attached to the upper lid construction at a membrane-to-roof site.

21. The container lid construction of claim 10 wherein the upper lid construction comprises a lid window and the membrane portion comprises an upper membrane surface, the upper membrane surface being outfittable with markings, the markings being viewable via the lid window.

22. A container lid method, the container lid method comprising the steps of:
forming a series of lid constructions, each lid construction comprising a resilient membrane portion, the resilient membrane portions each being configurable intermediate a relaxed configuration and an actuated configuration;
stacking the series of lid constructions while in relaxed configurations in a relaxed stacked columnar formation, the relaxed stacked columnar formation having a relaxed stacked lid volume; and
compressing the relaxed stacked columnar formation into a compressed stacked columnar formation by configuring the resilient membrane portions into the actuated configurations, the compressed stacked columnar formation having an actuated stacked lid volume, the actuated stacked lid volume being lesser than the relaxed stacked lid volume.

23. The container lid method of claim 22 comprising the step of maintaining the compressed stacked columnar formation.

24. The container lid method of claim 22 comprising the step of decompressing the compressed stacked columnar formation to a decompressed stacked columnar formation.

25. The container lid method of claim 24 wherein the step of decompressing the compressed stacked columnar formation to a decompressed stacked columnar formation provides a freely stacked lid formation, the freely stacked lid formation for enhancing a user's ability to retrieve a select number of lid constructions.

26. The container lid method of claim 22 wherein each resilient membrane portion is separable from the respective lid construction(s).

27. The container lid method of claim 22 each lid construction comprises a unibody construction

28. The container lid method of claim 22 wherein each resilient membrane portion provides a lid-traversing, beverage-damming construction, the beverage-damming constructions defining a lower beverage compartment and an upper beverage compartment when outfitted upon a beverage container, the beverage-damming construction for selectively transferring beverage intermediate the lower and upper beverage compartments.

29. The container lid method of claim 28 wherein each beverage-damming construction comprises at least one aperture, each aperture for enabling the user to selectively control beverage flow rates.

30. The container lid method of claim 28 wherein each beverage-damming construction is downwardly-bowed when in the relaxed configuration, the downwardly-bowed beverage-damming construction defining a beverage-pooling zone, the beverage-pooling zone for enhancing heat transfer from pooled beverage.

31. The container lid method of claim 22 membrane portion defines a beverage-pooling zone, the beverage-pooling zone being annularly-shaped, the annularly-shaped beverage-pooling zone for enhancing heat transfer from the pooled beverage.

32. The container lid method of claim 31 wherein the annularly-shaped beverage pooling zone enables radially directed heat transfer via a lid wall of the upper lid construction.

33. The container lid method of claim 29 wherein each beverage-damming construction comprises a series of apertures, the series of apertures for enhancing a user's ability to selectively control beverage flow rates.

34. A lid packaging method, the packaging method comprising the steps of:
forming a series of lid constructions, each lid construction comprising a spring portion, the spring portions being configurable intermediate a relaxed configuration and an actuated configuration;
stacking the series of lid constructions in a relaxed stacked columnar formation, the relaxed stacked columnar formation having a relaxed stacked lid volume; and
compressing the relaxed stacked columnar formation into a compressed stacked columnar formation by configuring the spring portions into the actuated configurations, the compressed stacked columnar formation having an actuated stacked lid volume, the actuated stacked lid volume being lesser than the relaxed stacked lid volume.

35. The lid packaging method of claim 34 comprising the step of maintaining the compressed stacked columnar formation.

36. The lid packaging method of claim 34 comprising the step of decompressing the compressed stacked columnar formation to a decompressed stacked columnar formation.

37. The container lid packing method of claim 34 comprising the step of inserting separable resilient membrane portions into respective lid construction during the step of forming the series of lid constructions.

38. The container lid packaging method of claim 34 wherein the step of forming the series of lid constructions comprises the step of forming each lid construction as a unibody construction.
